(19) United States
(12) Patent Application Publication
(10) Pub. No.: US 2011/0180619 A1
(43) Pub. Date: Jul. 28, 2011

(54) FOAMING HYPOCHLORITE CLEANING SYSTEM

(75) Inventors: Gregory A. Konishi, Scottsdale, AZ (US); Kristen Jacokes, Phoenix, AZ (US)

(73) Assignee: The Dial Corporation, Scottsdale, AZ (US)

(21) Appl. No.: 12/938,048

(22) Filed: Nov. 2, 2010

Related U.S. Application Data
(63) Continuation-in-part of application No. 12/693,043, filed on Jan. 25, 2010.

(51) Int. Cl. B05B 17/00; G01F 11/00

(52) U.S. Cl. 239/1; 222/323

(57) ABSTRACT

A foaming hypochlorite cleaning system is described that allows for easier cleaning of all hard-to-reach surfaces from all angles, especially underneath a range hood and up underneath the rim of a toilet bowl, and which comprises an alkaline hypochlorite and anionic surfactant composition contained in and dispensable from a package comprising an angled-neck sprayer bottle fitted with an invertible trigger sprayer assembly, wherein the cleaning system may be used in an entirely upside-down orientation to spray upwards at an acute angle.

### CROSS-REFERENCE TO RELATED APPLICATIONS

This application is a continuation-in-part of U.S. application Ser. No. 12/693,043, filed on Jan. 25, 2010.

### FIELD OF THE INVENTION

The present invention relates to a cleaning system comprising a foaming alkaline hypochlorite composition provided in an angled-neck sprayer bottle equipped with an invertible trigger sprayer assembly, which may be used upside-down to spray composition upwards at an acute angle.

### BACKGROUND OF THE INVENTION

Consumer and commercial cleaners are available in many forms such as ready-to-use liquid spray cleaners in spray-and-wipe (no-rinse) and those that require rinsing, ready-to-use powdered cleansers, pressurized aerosols, cleaning and disinfecting wipes, and dilutable multi-purpose liquid and powder concentrates. The ready-to-use spray-and-wipe trigger spray products include light-duty solvent cleaners for cleaning only lightly soiled surfaces such as windows, mirrors, chrome trim and the like. Many ready-to-use spray degreasers are available to remove light grease from stove tops and countertops. Some ready-to-use trigger spray cleaners that must be rinsed include powerful cleaners formulated to emulsify and saponify heavy kitchen grease. Bleach cleaners are designed to denature proteins and saponify the fats with high alkalinity. Cleaners may also sanitize or disinfect surfaces by delivering quaternary ammonium salts, chlorine bleach, or other antimicrobial active. Cleaners also include dilutable concentrates for light duty floor, wall, and countertop cleaning, specialized cleaning products useful on kitchen tile grout and worn sinks such as bleach containing stain removers (such as Clorox® Clean-®), and dry and crème scouring cleansers (such as Barkeepers Friend®, Comet® Cleanser, Soft Scrub with Bleach®, and the like). A truly ready-to-use foaming bleach spray cleaner has been somewhat of an aspiration, although many retail marketers claim their products deliver such broad applicability. Arguably, development of a foaming hypochlorite-based cleaner is problematic. The reason is that many thick foaming surfactants are not bleach compatible.

Arguably, trigger-sprayer bottles represent the most recognizable packaging for spray cleaning products regardless if for residential or institutional use. Spray bottles are now “stock” from countless distributors and are usually blow-molded clear or opaque HDPE or PET plastic. Labeling is usually in-mold, silkscreen, paper/laminate die-cut and glued, or plastic shrink sleeve, or some combination of these methods. Such packaging is almost always disposable and not refillable, and indeed many trigger sprayer assemblies are irreversibly attached to the opening of the sprayer bottles to make reuse of the bottle and trigger sprayer impossible. Trigger sprayers that were developed decades ago by such companies as AFA Corp, Owens, and Calmar are now conventional and familiar, and available at low cost from many distributors. The combination of the blow-molded sprayer bottle, having narrow neck and threaded opening, with the conventional trigger sprayer fitted to the opening and having a straw-type dip-tube positioned down into the bottle, form the most used and arguably the most recognizable package in all of cleaning However, this conventional packaging does not spray reliably at angles, and cannot spray at all upside-down. Tilting or inverting the bottle moves the liquid away from the open end of the dip-tube and liquid is no longer drawn up into the sprayer.

Inverted spraying has been described in the prior art, and invertible trigger sprayers are available in the marketplace to circumvent the problems with conventional sprayers. For example, U.S. Pat. No. 6,293,441 (Tasaki et al.); U.S. Pat. No. 5,979,712 (Montaner et al.); U.S. Pat. No. 5,775,548 (Hohmann et al.); U.S. Pat. No. 5,738,252 (Dodd et al.); U.S. Pat. Nos. 5,540,360, 5,467,901, and 5,462,209 (Foster et al.); U.S. Pat. No. 5,353,969 (Balderrama); U.S. Pat. No. 5,341,967 (Silvenis); and U.S. Pat. No. 4,775,079 (Grothoff), each describe invertible sprayers. Most of these sprayers incorporate a slide-valve that operates to close off the dip tube inlet and simultaneously open a liquid inlet at the bottom of the sprayer when the bottle is inverted. Other examples of invertible sprayer bottle packaging include inventions that keep the dip-tube of the sprayer under the surface of liquid in the sprayer bottle when the bottle is tilted or inverted. These include U.S. Pat. Nos. 5,875,940 and 6,059,152 (Mayfield) and PCT Application Publication WO 98/52863 (Helm) as examples of rigid dip-tubes positioned at an angle in the bottle, and U.S. Pat. No. 7,240,810 (Harrity et al.), U.S. Pat. No. 6,837,404 (Torres et al.), U.S. Pat. No. 6,394,319 (Pucillo), and U.S. Pat. No. 5,195,664 (Rhea) as examples of flaccid dip-tubes with a weighted end, which can move to the lowest point in the bottle by gravity if the bottle is tilted or inverted.

Angled-neck bottles not seen in trigger-spray cleaners, but are readily found in toilet cleaners to dispense gel cleaner under the rim of a toilet. U.S. Pat. No. 7,306,121 (Ophardt et al.) is an example of angled-neck delivery. Angled-neck bottle designs are numerous in the prior art and include such examples as U.S. Pat. D409495 (Hartman et al.) and D402561 (Utrup et al.), which are presumably used for toilet cleaners.

Angled-neck spraying by use of an angled-neck spray bottle equipped with a trigger sprayer has also been described in the prior art but not in the context of hard surface cleaners. An angled-neck bottle that sprays downwards when held in the upright position has been described in U.S. Patent Application 2003/0080209 (Dubreuil et al.). The Dubreuil invention allows downward spraying of an ironing aid onto clothing without the need to lift the spray bottle off the ironing board. An agricultural example of downward spraying from an uprightly held angled-neck bottle is found in U.S. Pat. No. 5,160,071 (Wright). Upwards spraying from an uprightly held angled-neck bottle is also known and is exemplified in U.S. Pat. Nos. 6,732,958 and 6,409,103 (Norville et al.), U.S. Pat. No. 6,027,041 (Evans), and in PCT Application Publication WO 2007/014416 (Withers). These inventions comprise either sprayer heads having a ball jointed nozzle that may be twisted to aim upwards, or bottles that have ball-jointed collars that may be twisted to aim the entire sprayer head upwards. The package depicted in FIG. 4 of the Evans '041 patent appears to combine a swiveling ball jointed sprayer head with an invertible sprayer (the sprayer having a flaccid, end-weighted dip-tube) although it is not clear what direction the sprayer may be rotated when the package is inverted as shown, and not clear what applications the disclosed invertible/rotating package is best used for.

What is clearly lacking in the prior art is a ready-to-use hypochlorite-based spray cleaning system that can be used to clean a wide variety of soiled surfaces from any and all angles. In particular, there is currently no hypochlorite-based spray cleaning system that can be used in the fully inverted position to spray liquid and optionally foam a multi-surface hypochlorite-based cleaner upwards at an acute angle. Therefore, the need exists for a bleach-based spray cleaning system that may be inverted and sprayed or foamed upwards to clean hard to reach surfaces while being held in the inverted position.

### SUMMARY OF THE INVENTION

The present invention is a foaming hypochlorite cleaning system comprising an aqueous, alkaline hypochlorite cleaning composition comprising a two surfactant system; an angled-neck trigger sprayer bottle containing the composition, and an invertible trigger sprayer assembly fitted to the sprayer bottle to deliver the composition from the sprayer bottle at any and all angles depending how the bottle is held. Most importantly, the cleaning system of the present invention may be used to clean under a range hood or up under the rim of a toilet bowl without stooping since the bottle may be fully inverted and held inside the range hood or toilet and sprayed upwards at an acute angle to wet or foam underneath. No other cleaning system currently exists that can deliver an alkaline bleach-based cleaner upwards at an acute angle when the package is held and operated upside-down. The salient feature of the present invention is the ability of the cleaning system to spray upwards at a sharper angle than would be possible from simply inverting a traditional sprayer bottle with straight neck and invertible sprayer assembly. The angled-neck of the sprayer bottle for the present invention allows the bleach cleaner to be sprayed at a more acute angle upwards. The aqueous, alkaline/anionic hypochlorite composition is useful for cleaning light soils and heavy grease alike. Optional cleaning instructions printed on either the bottle or on the sprayer head, or both, or supplied as separate literature, render a more complete cleaning system for both institutional and residential hard-surface cleaning.

### BRIEF DESCRIPTION OF THE DRAWINGS

FIG. 1 illustrates a front view of a preferred embodiment of an angled-neck sprayer bottle in accordance with the present invention.

FIG. 2 illustrates a front view of an embodiment of an angled-neck sprayer bottle equipped with a trigger sprayer in accordance with the present invention.

FIG. 3 illustrates a typical straight-neck spray bottle and trigger sprayer as found in the prior art.

FIG. 4 illustrates an embodiment of the cleaning system of the present invention comprising an angled-neck bottle equipped with a trigger sprayer, inverted to spray upwards at an angle.

FIG. 5 illustrates an embodiment of the cleaning system of the present invention and a prior art sprayer system comprising a straight-neck spray bottle superimposed.

FIG. 6 illustrates an inverse grip method of holding and operating the cleaning system of the present invention in the inverted configuration.

FIG. 7 illustrates the ability of the present cleaning system to spray up underneath the rim of a toilet bowl.

### DETAILED DESCRIPTION OF THE INVENTION

The following description is of exemplary embodiments only and is not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims. Additionally, though described herein in general terms of a cleaning system comprising an aqueous alkaline/anionic hypochlorite foaming cleaner composition and an angled-neck invertible sprayer package, other cleaning agents such as abrasives, oxygen or additional chlorine bleaches, disinfectants, deodorants, malodor counteractants, stain treating chemicals, rust chelators, gelling agents and other viscosity modifiers, surface modifying polymers, and the like, may be added to the composition without falling outside the scope of the present invention. Furthermore, the cleaning system of the present invention comprises an angled-neck sprayer bottle equipped with a trigger sprayer that may be sprayed upwards at a sharp angle while inverted. Provided the delivery system is an angled-neck sprayer bottle equipped with an invertible sprayer assembly manually operated by a pumping trigger, any changes to the general size, shape, materials of construction, color, and ornamentation of either the sprayer bottle or the trigger sprayer assembly fall within the scope of the present invention.

That being said, the present invention is a hypochlorite-based foam cleaning system minimally comprising an aqueous alkaline/anionic and hypochlorite composition in a package comprising an angled-neck sprayer bottle fitted with an invertible trigger sprayer assembly. With the present cleaning system thus configured, various surfaces may be more easily cleaned because of the ability of the cleaning system to spray upwards at a sharper angle when inverted than a conventional invertible sprayer system having only a straight-neck bottle. Surfaces that may be cleaned by the present system include all surfaces typically found in commercial and residential settings, e.g. kitchens and bathrooms, automobiles, trucks, and exterior surfaces in general. These surfaces include, but are not limited to, floors, walls, ceilings, countertops, sinks, shelving, steam tables, dish racks and drain boards, appliances, range hoods, stovetops, ovens, warming drawers, grills, pots and pans, sink drains, garbage disposals, trash compactors, waste baskets, toilets, showers, tubs, enclosures, tiled walls, windows, window tracks, cement, brick, aluminum sheds and structures, truck bodies, automobile exteriors and interiors, auto wheels, and car trim. The materials of construction of the surfaces that may be cleaned by the present invention include such materials as linoleum, vinyl, cultured marble, Corian®, Formica®, Fiberglas®, terrazzo, stone, cement, brick, china, porcelain, glass, stainless steel, brass, copper, iron, aluminum, plastic, chrome, tile, and the like.

The Package

The packaging element of the present invention comprises an angled-neck sprayer bottle fitted with a trigger sprayer assembly that works both upright and upside-down. An important feature of the present cleaning system is that it may be operated upside-down in order to spray detergent composition at an upward angle. Most importantly, the angled-neck of the bottle allows for spray of hypochlorite-based cleaning composition upwards at a steeper angle than possible from an inverted straight-neck sprayer bottle. As is typical for conventional sprayer bottles in the art, the preferred bottle for the present invention comprises an uppermost opening on the neck, which ends in a relatively planar flashing that closures can seal onto. The opening is circular and somewhat narrower in diameter than the neck itself, and preferably finished with external threads, bayonet provisions, lugs, ramps, or other means normally used in the art as fasteners that accept complementary finishes provided internally in the collar of the trigger sprayer assembly. With complementary provisions circumferentially around the external periphery of the bottle opening and on the inside of the collar of the trigger sprayer assembly, the sprayer may be fastened onto the opening of the bottle either reversibly, or substantially irreversibly, by the mating of these complementary threads, bayonets/lugs, ramps, and the like. Simple screw threads are commonly employed as the fastening means to secure the collar of a sprayer assembly onto the opening of a sprayer bottle, and screw threads are preferred for the present invention. If ratchet provisions are provided circumferentially around the bottle opening and inside the collar of the trigger sprayer, it is possible that the trigger sprayer may be screwed onto the neck of the bottle irreversibly since the collar of the sprayer cannot be rotated in the reverse direction against the ratchet teeth. Such ratchet provisions are found throughout the art. Alternatively, bayonets and lugs may be provided on the bottle neck and trigger sprayer collar such that the trigger sprayer is pushed down and irreversibly locked onto the neck of the sprayer bottle. Such provisions are well known and are disclosed in U.S. Pat. No. 7,478,739 to Foster, incorporated herein in its entirety. The bayonet connectors disclosed in the '739 patent are the most preferred fastening means in the present invention for securing the invertible sprayer assembly onto the opening of the angled neck bottle.

The Angled-Neck Sprayer Bottle

The sprayer bottle for use in the present cleaning system must include an “angled-neck.” “Angled-neck” is defined herein to mean a sprayer bottle where the upper narrower gripping region (i.e., the neck of the sprayer bottle) is tilted at an angle from vertical in order to place the flashing of the opening of the bottle at an angle from horizontal. In a conventional spray bottle, (i.e. one without an angled-neck), an imaginary axis drawn centrally through the opening and down the neck of the bottle lines up relatively parallel or even coaxially with a central vertical axis drawn through the generally globular body of the bottle, and the flashing of the opening in a traditional sprayer bottle is essentially horizontal. Another way to describe a conventional sprayer bottle is that the flashing at the top of the opening on the neck of the bottle will be substantially parallel to the relatively flat bottom on the body of the sprayer bottle. When a trigger sprayer assembly is coupled to the opening of a conventional straight-necked sprayer bottle, the trigger sprayer will be substantially horizontal, and the spray pattern emanating from the sprayer upon operation of the trigger sprayer will necessarily be in a generally horizontal direction. If the trigger sprayer assembly is configured to operate upside-down, the spray direction will still be in a generally horizontal direction when the entire sprayer bottle package is fully inverted.

The spray pattern emanating from a trigger sprayer suitable for use in the present cleaning system is preferably in a cone shape, having a central axis that defines the general direction of spray. But regardless of the spray pattern for the present invention, (e.g. conical, flat, square, or even a narrow jet stream), the spray from a trigger spray cleaner sprayer assembly will always be expelled from the sprayer in a generally discernable direction so that the surface to be cleaned can be purposely and accurately wetted with cleaner. Most spray cleaners are designed to spray in a directional, controlled, and relatively compact spray pattern so that the consumer can accurately aim at, and wet, only the area to be cleaned. Sprayers configured to mist and/or aerosolize (e.g. as seen in most air fresheners) have an emanation that may be considered not to have a clearly defined spray direction. In those products, a mist having only an obscure spray direction is acceptable and desirable since no surface is intended to be wetted by the emanating mist. The present invention is distinguished from misting products and will preferably have a compact and directional spray pattern such as conical. The spray may comprise a foam texture/lather, or simply be comprised of liquid droplets, regardless of the spray pattern.

In an “angled-neck” sprayer bottle, such as for the present invention, the neck will be tilted from vertical and the flashing of the opening of the bottle will be displaced from horizontal. It is understood that when a trigger sprayer assembly is coupled to the opening of an angled-neck sprayer bottle in the present invention, the trigger sprayer will necessary aim downwards at a perceivable angle. Therefore, when such an angled-neck sprayer package is set on a horizontal surface, or held upright with the bottom of the bottle parallel to the floor, the spray emanating from the sprayer upon pumping operation of the trigger will necessarily be in a direction that is angled perceivably downward from horizontal.

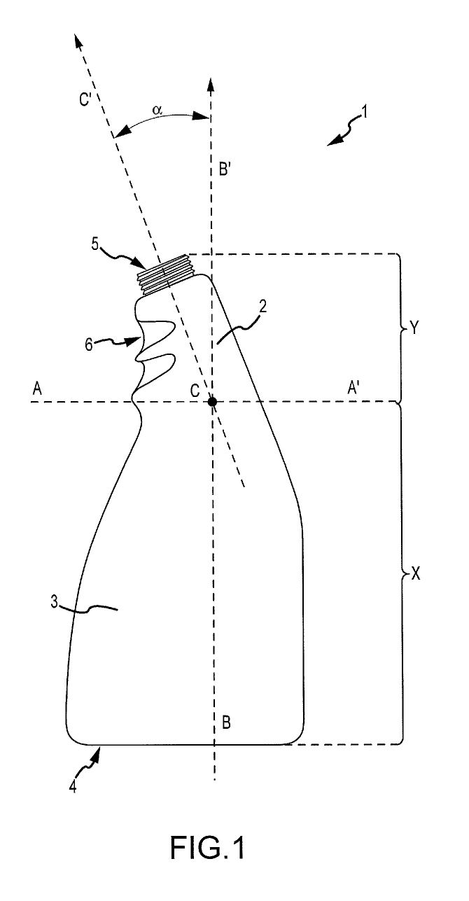

The angled-neck feature of the bottle incorporated in the present invention is best understood by way of drawing figures. FIG. 1 is a front view of a preferred angled-neck sprayer bottle for use in the cleaning system of the present invention. As seen in FIG. 1, the preferred sprayer bottle 1 is similar to a customary sprayer bottle in that a neck region 2 is provided that is narrower in diameter than a main body 3 of the bottle, such that the consumer has an area on which to grip the bottle to easily lift and use it. Certainly just as many designs (shapes/sizes/colors) are possible for an angled-neck bottle as any conventional straight-necked sprayer bottle. For example, the neck region may be offset from the central axis of the body of the bottle, or the neck may be relatively coaxial with the central axis of the body of the bottle. The body of the preferred bottle generally provides the majority of the liquid fill capacity of the bottle, although some liquid may be filled up into the neck region as well, and this becomes important with clear bottles so as not to appear under-filled to the consumer. The body portion is usually and preferably round, oval, or oblong in cross-sectional shape in order to provide an interior capacity. The body of a sprayer body is often referred to as “globular” to indicate that it is capable of containing a volume of liquid and that it is generally round in cross-section. The shape of the body of a spray bottle may be seen by looking at the bottom of the bottle, with the shape of the generally flat bottom of the bottle usually representing a cross-section cut anywhere through the body. This shape is usually maintained as the body narrows and merges with the base of the neck of the bottle. The neck of the bottle is generally elongate in height, at various lengths compared to the body, and the cross-section of the neck is preferably round, oval, or oblong. The bottle for use in the present cleaning system may be any combination of shapes for the body and for the neck of the bottle. For example, the body of the bottle may be generally cylindrical in shape and the neck also cylindrical but narrower in diameter for gripping. Or the body may be generally globular with an oval cross-section and the neck may be cylindrical. Or any of the other possible combinations of shapes are within the scope of the present invention. For the present invention, it is preferable to have at least one finger recess 6 molded into the neck of the bottle to assist the consumer in gripping the neck region of the bottle with a single hand. Such grip designs appear throughout the marketplace in conventional sprayer bottles. For the present invention, a firm grip is important in anticipation of tilting and inverting the bottle to spray upwards at various times during the cleaning task. Ideally there are two finger recesses to accommodate both the second and third fingers of the user. The index finger is usually left extended to operate the trigger of the sprayer.

For reference purposes, bottle 1 in FIG. 1 is understood to be standing in its “upright” position when the relatively flat bottom 4 of the bottle 1 rests flat on a relatively horizontal table or countertop, or when the bottle 1 is held in the air such that the bottom 4 is relatively parallel to the floor of a room. In such an upright position, the opening 5 will be pointed generally upwards, as the bottle 1 is so oriented in the drawing figure. While the bottle 1 stands in its upright position and viewed in the front plan view shown in FIG. 1, a horizontal line A-A′ and vertical line B-B′ may be drawn at right angles to one another through the bottle 1 as indicated for further analysis of the angled-neck. Horizontal line A-A′ may be drawn just under the lowest finger recess 6 of the neck region 2 in order to separate the bottle into approximately a “neck region” 2 and a “body region” 3. If no finger recesses are provided on the neck of the bottle, the line A-A′ may be drawn at approximately the position where the larger globular-shaped body of the bottle reduces in diameter and overall cross-sectional size to contiguously merge into what would be traditionally considered the “neck” or gripping portion of a sprayer bottle. As shown in FIG. 1, the neck 2 of the bottle for use in the present invention is preferably tilted from the vertical B-B′ line by the angle “α.” As mentioned above, an imaginary axis C-C′ may be drawn coaxially through the neck 2 of the bottle and through the axis of the opening 5. In this way, the angle to which the neck of the bottle is displaced from vertical is readily apparent and measurable. As illustrated, the angle “α” is preferably from about 3° to about 80°, and most preferably from about 5° to about 45°. Thus defined and illustrated, angle “α” is the preferred tilt of the angled-neck sprayer bottle for the present invention and it is the angle at which the planar flashing of the opening of the bottle is displaced from horizontal. Still referring to FIG. 1, the angled-neck bottle usable for the present invention is preferably finished at the opening 5 with external screw threads or other fasteners such as bayonet provisions onto which the trigger sprayer assembly, configured with the necessary complementary fasteners, may attach. Such an opening for a sprayer bottle for the present invention may be from about ½ cm to about 2 cm in height and from about 1 cm to about 3 cm in diameter, as is typical for most injection blow molded plastic sprayer bottles regardless if the neck is angled per the present invention or straight as per a conventional bottle.

Still referring to FIG. 1, the ratio of the height of the body region, X, to the height of the neck region, Y, is preferably from about 3:1 up to about 1:1. More preferred is to have a ratio of body height X to neck height Y of about 2:1. In the most preferred configuration, body height X may be about 16 cm whereas neck height Y may be about 8 cm. In this way, the bottle 1 depicted in front view in FIG. 1, having this total height along with a proportionally oval shaped cross-sectional depth and width, will have a fill volume of around 750 mL (about 25.4 fluid oz.) and will be easily gripped around the neck region by the user of the cleaning system. Both smaller and larger capacity bottles are anticipated and within the scope of the present invention. For larger capacity sprayer bottles, it may be preferably to extend the neck region relative to the body region and provide for gripping texture (such as bumps) and deeper, more pronounced finger recesses.

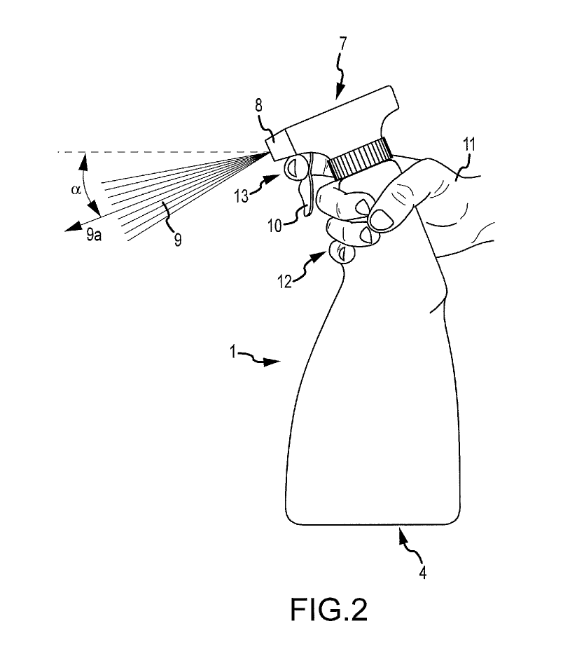

FIG. 2 is a front view of the angled-neck sprayer bottle 1 of the present invention equipped with a trigger sprayer assembly 7. Trigger sprayers are an integral part of spray cleaner packaging and come in many shapes, sizes, colors, and functions (e.g. spray, foam, and stream). Trigger sprayer assembly 7 is shown with a typical appearance that is defined by the external shroud of the sprayer. Such assemblies are amply described in the literature and operate by movement of an internal piston that is manually moved by the lever that is referred to as the trigger to suck up liquid through a straw-like dip-tube and expel it through a nozzle as a pattern of droplets or as directional foam. The trigger sprayer 7 for the present invention may include such a nozzle 8 and a trigger lever 10 for expelling the product spray. Nozzle 8 may be configured for a particular patterned spray, such as conical, flat, square, or narrow stream, and/or may allow for a directional foam delivery. Many sprayers today feature moveable nozzles that may be rotated between “OFF/STOP,” “STREAM,” and “SPRAY” positions. Some also have a hinged screen or other porous member usable to create a foamed delivery when the screen is flipped and snapped in front of the outlet of the nozzle. As shown in FIG. 2, the direction 9a of spray 9 is necessarily downwards when the angled-neck bottle of the present invention is sprayed while standing in its upright position. More precisely, when the package of the present invention is held upright with the bottom 4 of the bottle 1 parallel to the floor or resting flat on a horizontal surface, the general direction 9a of the emanating spray or foam is displaced from horizontal by angle “α.” Angle “α” is preferably from about 3° to about 80° and most preferably from about 5° to about 45°. FIG. 2 also illustrates that a hand 11 may conveniently grip the angled-neck region of the bottle 1 when the fingers 12 surround the neck of the bottle. The index finger 13 may be left extended for pulling the trigger 10 to effect the pumping operation and expel the product 9. As will be described more thoroughly below, it is central to the present invention that trigger sprayer assembly 7 operate from any position, even when the bottle 1 is completely inverted. Such invertible sprayer assemblies are well known in the art and are described below.

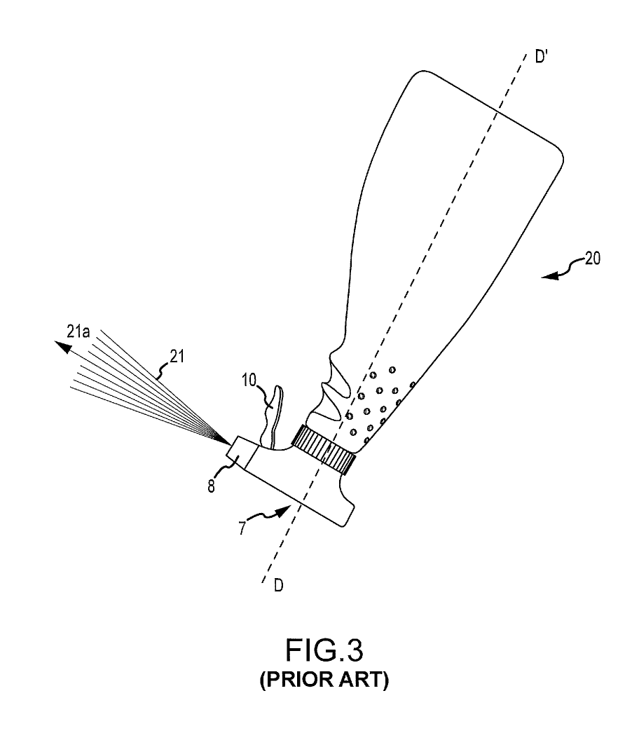

FIG. 3 depicts the typical prior art sprayer bottle 20 that may be sprayed upside-down so long as the trigger sprayer assembly 7 is configured as an invertible trigger sprayer assembly. However, the general spray direction 21a of the emanating spray 21 will not be angled upwards to any degree unless the bottle 21 is held close to horizontal rather than close to fully inverted. In other words, the closer the conventional straight-neck bottle 20 is held to a fully inverted orientation, the closer the spray direction 21a approaches true horizontal, which defeats any purpose to inverting the sprayer bottle in the first place. To spray upwards at a steeper angle than depicted by spray direction 21a in FIG. 3, the conventional spray cleaner with straight-necked bottle and invertible sprayer will need to be held closer to horizontal rather than fully inverted. However, the need will occasionally arise when the prior art sprayer bottle must be held fully inverted in order to fit the sprayer head into a confined space, such as inside an oven. The prior art sprayer bottle shown in FIG. 3 is limited it its ability to spray upwards while the user keeps the globular body of the bottle inverted and as high as possible. Keeping the body of the bottle inverted and up high is important when cleaning the inside top surface of an oven, otherwise the body of the bottle will hit against the sides and/or bottom of the oven.

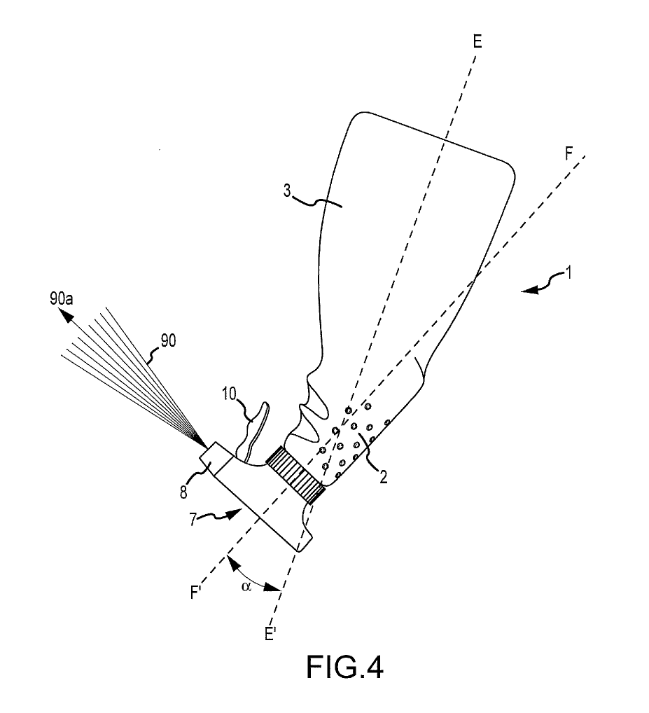

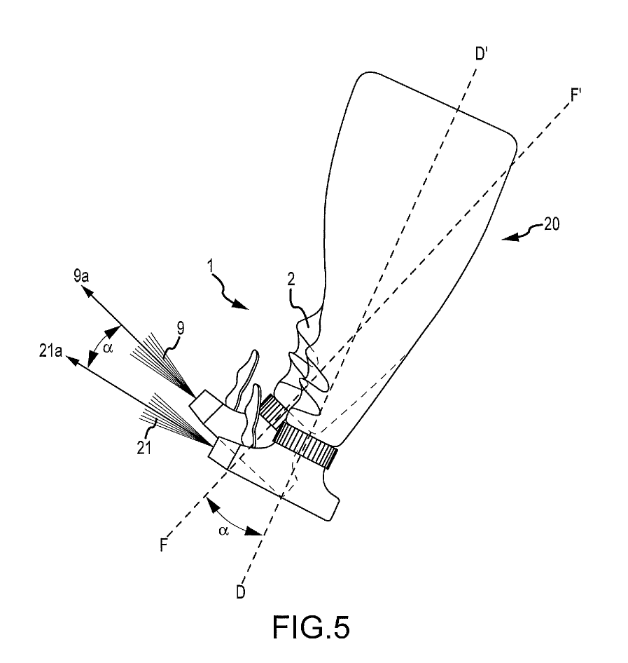

FIGS. 4 and 5 illustrate the advantage of the angled-neck invertible sprayer system of the present invention over a straight-neck sprayer system equipped with an invertible sprayer as found in the prior art. As described above, and now shown illustrated in FIG. 4, the present cleaning system is comprised of an angled-neck bottle 1 with body portion 3 and angled neck region 2. When the body 3 of the preferred bottle 1 is held partially inverted along axis E-E′ as shown, the axis F-F′ drawn down through the axial center of neck 2 of the bottle will be preferably displaced from axis E-E′ by angle “α” of from about 3° to about 80° and more preferably from 5° to about 45°. Spray emanation 90 will be in a direction 90a that is generally upwards at angles heretofore unobtainable from traditional sprayers held in their upside-down or nearly upside-down positions.

The most marked advantage to the present invention is shown more clearly in FIG. 5, where the prior art sprayer package and the sprayer package of the present invention are superimposed. As illustrated in FIG. 5, when the conventional sprayer 20 is held partially inverted along axis D-D′, it may be used to dispense spray 21 in a general spray direction 21a. As discussed above, spray direction 21a is a consequence of the straight-necked bottle. On the other hand, the sprayer package of the present invention comprises bottle 1 with angled-neck 2 rather than a conventional straight-neck, and the spray 9 from the present invention is along general direction 9a. Spray direction 9a is displaced at an angle “α” from spray direction 21a because of the angled-neck 2 of the sprayer bottle of the present invention. FIG. 5 illustrates that the sprayer package of the present cleaning system can be sprayed upwards at a sharper angle than possible from a conventional spray cleaner held in the inverted position. Thus, the present cleaning system may be more easily sprayed up inside an oven and up underneath a range hood than would be possible by simply inverting a traditional sprayer bottle equipped with an invertible sprayer assembly.

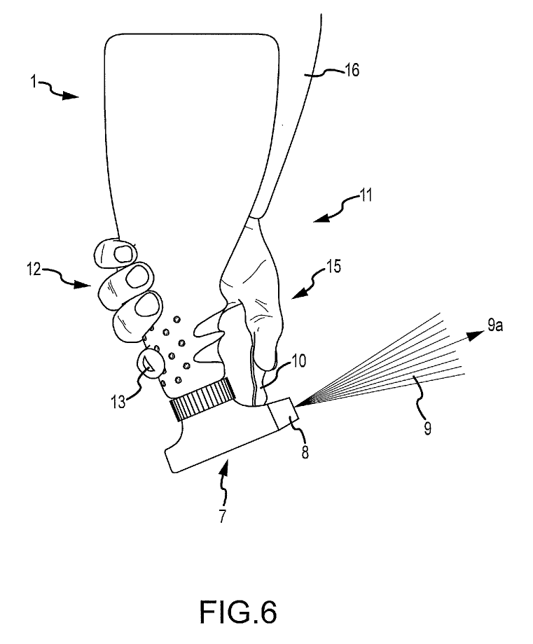

FIG. 6 illustrates an alternative operation of the present cleaning system by gripping of the package 1 by human hand 11 to spray product 9 in a general upwards direction 9a when the package is held in a partially inverted position. As shown in FIG. 6, (and contrasted to FIG. 2), the package of the present invention may be held by an “inverse grip” that allows for the thumb 15 of the user to operate the trigger lever 10 rather than the index finger 13. Some users have found it more comfortable to reverse their grip when inverting the package and instead operate the trigger 10 with their thumb 15 as shown. Furthermore, the forearm 16 of the operator lends support to the bottle. With the bottle 1 leaning against the forearm 16 of the user, the tendency of the bottle to cantilever over is minimized. This “inverted grip” with thumb operation also allows spraying without stooping and bending.

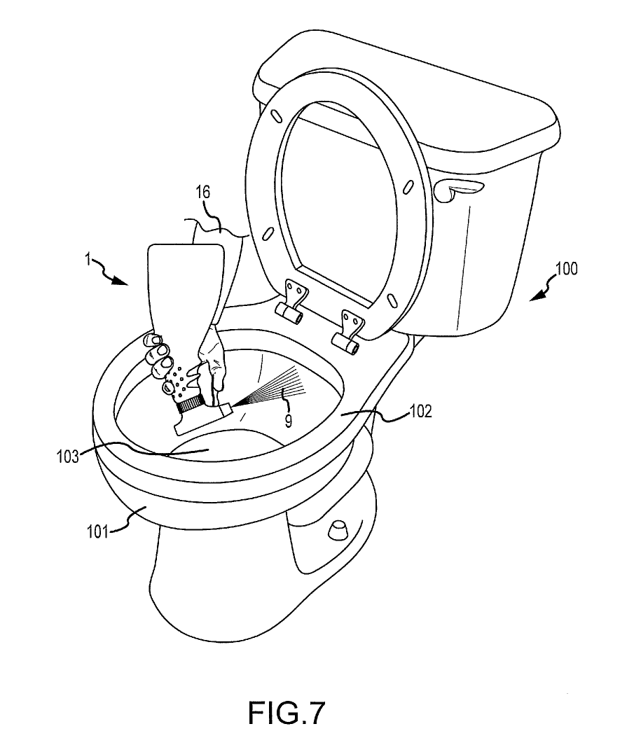

FIG. 7 illustrates the ability of the cleaning system to spray up underneath the rim 102 of a toilet bowl 101. The unique packaging of the present invention allows the upward spray of product 9 even though the bottle 1 is inverted and lowered within the toilet bowl 101 of the toilet 100. Inversion of the package is necessary to avoid collision between the body of the bottle 1 and the toilet bowl 101, and to keep the package out of the toilet water 103. As mentioned, with the “inverted grip” the user's forearm 16 lends support to the bottle when inverted so that the tendency to cantilever back over is minimized. The other hand of the user (not shown) may also be used to hold onto the body of the bottle. The angled-neck of the sprayer bottle allows for the spray 9 to be upwards at a sharp angle when the package is inverted and sprayed from a point inside the bowl of the toilet. The present cleaning system may be used to clean all the other exterior and interior parts to the toilet 100 by spraying upright, inverted, and at all other necessary angles.

In further exemplary embodiments of the present cleaning system, the sprayer may be sprayed upwards underneath a kitchen range hood. For cleaning under the range hood and around a stove and cook-top in general, the ordinary “pistol-grip” as shown in FIG. 7 may be a preferable way to grip the cleaning system. The unique packaging of the present invention allows the upward spray of foaming bleach cleaner even though the bottle is inverted. Inversion of the package may be preferable in order to avoid collision between the body of the bottle and the top of the range when there is reduced clearance between the two (e.g. when there is an above-the-range microwave oven and vent combination). The angled-neck of the sprayer bottle allows for the spray of bleach cleaner to be upwards at a sharp angle when the package is inverted and sprayed from a point below or up inside the range hood.

In a further exemplary embodiment, the present cleaning system may be used to deliver bleach cleaning composition up inside an open oven without excessive stooping. The unique packaging design of the present invention allows the user to stand without stooping and spray upwards inside the oven as a method to clean the inside top surface and the racks of the oven. The product spray may be emitted sharply upwards into the open oven by simply holding the cleaning system in the inverted position at the open door of the oven. As mentioned, with the “inverted grip” the user's forearm provides support for bottle, minimizing the tendency for the bottle to cantilever over when full and heavy. The other hand of the user may also be used to hold onto the body of the bottle if the system feels unstable when inverted.

The Invertible Sprayer

The hypochlorite cleaning system of the present invention requires an invertible trigger sprayer assembly. Most any invertible sprayer will suffice for the present invention. A “trigger sprayer” for purposes of the present invention is assumed to mean an assembly mounted to the top of a container of liquid which has a trigger handle that can be squeezed to cause pumping and dispensing of liquid from a nozzle. As discussed, trigger sprayers are exceedingly familiar and disclosed in countless prior art references. One good example is the trigger sprayer disclosed in U.S. Pat. No. 4,527,741 (Garneau), incorporated herein in its entirety. Trigger sprayers, such as the one disclosed by Garneau, are expected to minimally comprise a body with a bore including a cylindrical linear passageway, one end of which is connected to a dip-tube that protrudes into a source of fluid (i.e. inserted into a bottle containing liquid), the other end of the bore connected to the outlet nozzle, and a piston within the passageway that operates to pump the liquid up the dip-tube and expel it out through the nozzle. Most trigger sprayers will also include a check valve of sorts to keep the system primed with liquid, and a spring mechanism to facilitate the manual pumping of the trigger lever (i.e. a spring attached either to the piston or to the lever to facilitate return of the lever to its starting position after it is pulled once by the operator). The preferred sprayer for the present invention, even though it must be an “invertible sprayer,” may comprise these same internal components (body, bore, piston, lever, check valve, nozzle, etc.) intimately disclosed and claimed by Garneau in the '741 patent. Another example of a typical trigger sprayer assembly may be found in U.S. Pat. No. 5,222,637 (Giuffredi), incorporated herein in its entirety.

What is meant by “invertible sprayer” for the present invention is that the trigger sprayer may be operated at all angles, even inverted, because the sprayer head has been configured with the ability to continue pumping liquid regardless of bottle position, usually by providing an alternative liquid inlet at the base of the sprayer head or a flaccid dip tube that is weighted. Invertible sprayers usable in the present cleaning system include, but are not limited to, those disclosed in U.S. Pat. No. 6,293,441 (Tasaki et al.); U.S. Pat. No. 5,979,712 (Montaner et al.); U.S. Pat. No. 5,775,548 (Hohmann et al.); U.S. Pat. No. 5,738,252 (Dodd et al.); U.S. Pat. No. 5,540,360 (Foster, et al.); U.S. Pat. No. 5,467,901 (Foster et al.); U.S. Pat. No. 5,462,209 (Foster et al.); U.S. Pat. No.5,353,969 (Balderrama); U.S. Pat. No. 5,341,967 (Silvenis); U.S. Pat. No. 4,775,079 (Grothoff); U.S. Pat. No. 7,240,810 (Harrity et al.); U.S. Pat. No. 6,837,404 (Torres et al.); U.S. Pat. No. 6,394,319 (Pucillo); and U.S. Pat. No. 5,195,664 (Rhea), and in U.S. Patent Application Publication 2008/0277430 (Maas et al.), and with each reference incorporated herein in their entireties. Invertible sprayer assemblies featuring a movable element (e.g. a small metal ball in a slide-valve) that opens a secondary liquid inlet when the sprayer is inverted, such as disclosed by Foster ('360, '901, and '209), Hohmann ('548), Tasaki ('441), and most particularly by Maas, et al. (Application Publication '430), are the most preferred for the present invention, although the sprayers that comprise flaccid dip-tubes with weighted ends are usable. The most preferred sprayer is the sprayer assembly disclosed by Maas in application publication '430, incorporated herein in its entirety. Maas refers to the disclosed sprayer as a “dosing head” that we equate and use interchangeably with the term “sprayer assembly.” Maas discloses a sprayer/dosing head that includes a secondary inlet opening that is closable by means of an element operated by gravity. The Maas sprayer thus operates in the upright position, with fluid drawn up through the dip-tube and primary inlet opening, while the secondary inlet opening is kept closed by the closing element that is urged on by gravity. When the Maas sprayer is inverted, the closing element is lifted from the secondary inlet opening by gravity, which is then left open for passage of fluid. The closing element disclosed by Maas is best gleaned from FIG. 16 of the Maas '430 application publication. In that drawing figure, the element appears to be a small movable ball (element 130) that is free to move under the forces of gravity. The sprayer disclosed by Maas in the '430 application is believed to be available under the trade name “OpAd™ OnePak™ Precompression Snap-On Sprayer” from the AFA Dispensing Group, Netherlands. The AFA sprayer not only is an invertible sprayer for upside-down spraying, but also is one that features a precompression engine, constant prime, and a flattop shroud usable as a labeling area (instructions for use, or advertisement). Thus the preferred packaging for the present invention is the angled-neck bottle as illustrated in the drawing figures of the present application, equipped with an invertible trigger sprayer assembly as disclosed in the various references incorporated herein. Most preferred is a sprayer bottle as described above (and illustrated in the present drawing figures) with a neck angled at from about 3° to about 80°, or most preferred at an angle of from about 5° to about 45°, equipped with the invertible trigger sprayer assembly (dosing head) disclosed by Maas, et al. in U.S. Patent Application No. 2008/0277430.

The invertible trigger sprayer for use in the present cleaning preferably comprises a nozzle that allows selection between various positions, such as “OFF”/“STOP”, “SPRAY”, “STREAM”, and “FOAM”, and/or selection between spray patterns such as conical, flat, and the like. Many examples of such nozzles exist in the prior art and may be incorporated onto the end of the invertible sprayer for the present invention. Nozzles are disclosed in the following references that are incorporated herein in their entireties: U.S. Pat. No. 3,843,030 (Micallef); U.S. Pat. No. 4,161,288 (McKinney); U.S. Pat. No. 4,227,650 (McKinney); U.S. Pat. No. 4,247,048 (Hayes); U.S. Pat. No. 4,730,775 (Maas); U.S. Pat. No. 5,664,732 (Smolen, Jr. et al.); and U.S. Pat. No. 6,382,527 (Dukes, et al.).

Instructions for Use

The cleaning system of the present invention may include use instructions printed on the bottle, the sprayer shroud, or both, or printed on separate literature such as a leaflet, booklet, or bottle neck hanger. For example, the present cleaning system may include printed instructions for using the system in the inverted position to spray cleaner up underneath the range hood or commercial ventilators, and up inside an oven. The instructions may provide diagrams/photos of the various ways to grip the bottle for upright versus inverted use, (e.g. the configuration in FIG. 2 and FIG. 6, respectively). There may be additional instructions for using the cleaning system to clean a wide variety of institutional and residential hard surfaces including toilets, showers, tubs, tile, stovetops, warming drawers, dishwashers, drying racks, steam tables, counters, sinks, fixtures, floors, and the like. The instructions may include specific details regarding dwell time, if the surface needs to be rinsed or simply wiped, surface compatibility with the present alkaline composition, storage conditions, and safety. If the cleaning system includes a nozzle moveable between various positions (“OFF”/“STOP”, “SPRAY”, “FOAM”, “STREAM”, etc. as referenced above), instructions for changing between these selections can be delineated in the use instructions. The top of the shroud of the OpAd™ sprayer is the ideal place to print graphics showing the nozzle positions and the resulting spray patterns.

### The Foaming Hypochlorite Cleaning Composition

In an exemplary embodiment of the present invention, the foaming hypochlorite cleaning composition comprises a disulfonate surfactant, an alkyl sulfate surfactant, a hypochlorite source, and water.

In other exemplary embodiments, the composition comprises additional anionic surfactants, nonionic surfactants, amphoteric surfactants, builders, chelants, solvents, buffers, and miscellaneous adjuvant such as dyes, pigments, fragrance, encapsulated fragrance, preservatives, and the like.

Hypochlorite Source

The foaming hypochlorite cleaning system of the present invention includes a source of hypochlorite. The source of the hypochlorite for the present composition can be selected from various halogen bleaches. As examples thereof, the bleach may be preferably selected from the group consisting essentially of the alkali metal and alkaline earth salts of hypohalite, hypohalite addition products, haloamines, haloinines, haloimides, and haloamides. These also produce hypohalous bleaching species in situ. Preferred is hypochlorite and compounds that generate hypochlorite in situ in aqueous solution. Exemplary bleaching agents which yield a hypochlorite species in aqueous solution include alkali metal and alkaline earth metal hypochlorites, hypochlorite addition products, chloramines, chlorimines, chloramides, and chlorimides. Specific examples of compounds of this type include sodium, potassium, lithium, and calcium hypochlorite, monobasic calcium hypochlorite, dibasic magnesium hypochlorite, chlorinated trisodium phosphate dodecahydrate, potassium dichloroisocyanurate, sodium dichloroisocyanurate, sodium dichloroisocyanurate dihydrate, trichlorocyanuric acid, 1,3-dichloro-5,5-dimethylhydantoin, N-chlorosulfamide, Chloramine-T, Dichloramine-T, Chloramine-B and Dichloramine-B. Of the multitude of hypochlorite sources that may be used in the present invention, most preferred is to use sodium hypochlorite, potassium hypochlorite, or a mixture thereof. Preferably the present composition incorporates a sufficient amount of a hypochlorite source, such as sodium hypochlorite, to result in an active hypochlorite concentration in the final composition at about 0.5% to about 3.0%. More or less hypochlorite raw material may be added as needed depending on the concentration of the raw material used (e.g. 6%, 12.5%, 15% actives). Most preferred for use in the present invention is sodium hypochlorite. In particular, 12.6% sodium hypochlorite available from Rowell is most useful as the raw material to provide the active hypochlorite in the present composition.

Surfactant Components

The foaming hypochlorite cleaning formula for use in the cleaning system of the present invention minimally includes two anionic surfactants, namely a disulfonate and an alkyl sulfate, and may also comprise other anionic surfactants such as alkyl ether sulfates, various sulfonates, ether carboxylates, and fatty acid soaps. The present detersive composition may also include nonionic surfactants such as an amine oxide, alkyl polyglycoside, an alcohol ethoxylate, or a fatty acid alkanolamide, and may include optional amphoteric surfactants such as a betaine. The decision to combine these optional nonionic, anionic and amphoteric surfactants with the preferred disulfonate and alkyl sulfate surfactant mixture may be based on their stability in a hypochlorite-based composition, their contribution to increased hypochlorite storage stability over time, effect on foam/vertical cling and effect on the overall cleaning/bleaching efficacy of the composition.

The disulfonate surfactants preferred for use in the present cleaning system include the alkyl diphenyloxide disulfonates having the general formula X⁺⁻O₃S—(C₆H₃R)—O—(C₆H₄)—SO₃⁻X⁺, where R is a linear or branched alkyl substituent with from about 6 to about 18 carbon atoms, and where both X⁺ are alkali metals, typically Na⁺, or both hydrogen (H), or a mixture of salts and protonated sulfonic acid groups. The most useful of these compounds for inclusion in the present invention are available from Pilot and include: Calfax® 6LA-75, where R is linear C₆ and both X are hydrogen; Calfax® 10L-45, where R is linear C₁₀ and both X are Na⁺; Calfax® 10LA-75, where R is linear C₁₀ and both X are hydrogen; Calfax® 12L-45, where R is linear C₁₂ and both X are Na⁺; Calfax® DB-45, where R is branched C₁₂ and both X are Na⁺; Calfax® DBA-70, where R is branched C₁₂ and both X are hydrogen; and, Calfax® 16L-35, where R is linear C₁₆ and both X are Na⁺. It should be understood that as with virtually all synthetic surfactants, these compounds are distributions of alkyl chain lengths and extent of sulfonation (e.g. averaging about 2 sulfonate groups). Placing any of these substances in strong alkali such as NaOH or KOH will cause exchange of ions (e.g. K⁺ for Na⁺ or vice versa) and/or neutralization of existing protonated sulfonic acid groups (SO₃H) into the corresponding salt (e.g. resulting in SO₃⁻Na⁺ or SO₃⁻K⁺ groups). There is no certainty as to what particular salts may exist when any of these substances are used in strongly alkaline compositions that include other ions because of ion exchange. The alkyl diphenyloxide disulfonate compounds function as detergents and hydrotropes and they have stability in chlorine bleach compositions. The most useful disulfonate for the present invention is disodium dodecyl diphenyloxide disulfonate, available from Pilot as Calfax® DB-45, although use of Calfax® DBA-70 in a highly caustic environment (e.g. KOH, or NaOH) achieves the same result although the counterions may be sodium, potassium, or mixed. Most preferred is to incorporate from about 0.5% to about 1.5% active disulfonate in the present cleaning system. For example, 1.1% of 45% active Calfax® DB-45 will deliver 0.5% active disulfonate in the composition and 3.33% Calfax® DB-45 will deliver 1.5% active disulfonate.

The alkyl sulfates, also known as alcohol sulfates, are also most preferred for use in the present invention, and used in combination with the above discussed disulfonate surfactants. The preferred alkyl sulfate anionic surfactants have the general formula R—O—SO₃⁻M⁺ where R is an alkyl chain of from about 8 to 18 carbon atoms and M is an alkali or alkaline earth metal. These materials may also be denoted as the sulfuric monoesters of C₈-C₁₈ alcohols, wherein the preferred examples include sodium n-octyl sulfate, sodium decyl sulfate, sodium palmityl alkyl sulfate, sodium myristyl alkyl sulfate, sodium dodecyl sulfate, sodium tallow alkyl sulfate, sodium coconut alkyl sulfate, and mixtures of these surfactants, or of C₁₀-C₂₀ oxo alcohols, and those monoesters of secondary alcohols of this chain length. Also useful are the alk(en)yl sulfates of said chain length which contain a synthetic straight-chain alkyl radical prepared on a petrochemical basis, these sulfates possessing degradation properties similar to those of the corresponding compounds based on fatty-chemical raw materials. From a purely detersive standpoint, C₁₂-C₁₆-alkyl sulfates, C₁₂-C₁₅-alkyl sulfates, and also C₁₄-C₁₅ alkyl sulfates, are all preferred. However, in combination with the above mentioned disulfonate surfactant, the most preferred alkyl sulfates have a shorter chain length and may function more as a hydrotrope in the composition rather than a detersive surfactant. Most preferred is to use sodium n-octyl sulfate (sodium capryl sulfate) from Cognis sold under the trade name of Texapon® 842. The preferred level of alcohol sulfate in the present invention is from about 0.1% to about 5%. Most preferred is from about 0.1% to about 2%. The most preferred ratio of sulfate to disulfonate, when these anionic surfactants are used together in the present invention, is from about 1:1 to about 2:1.

The present cleaning system may optionally include additional anionic surfactants. Suitable additional anionic surfactants include the sulfonates. Preferred surfactants of the sulfonate type are C₉₋₁₃ alkylbenzenesulfonates, olefinsulfonates, and hydroxyalkanesulfonates, as are obtained, for example, from C₁₂₋₁₈ monoolefins having a terminal or internal double bond by sulfonating with gaseous sulfur trioxide followed by alkaline or acidic hydrolysis of the sulfonation products. Sulfonate surfactants that are preferred for use in the present invention include the alkyl benzene sulfonate salts. Suitable alkyl benzene sulfonates include the alkali metal and alkaline earth salts of straight or branched-chain alkyl benzene sulfonic acids. Alkyl benzene sulfonic acids useful as precursors for these surfactants include decyl benzene sulfonic acid, undecyl benzene sulfonic acid, dodecyl benzene sulfonic acid, tridecyl benzene sulfonic acid, tetrapropylene benzene sulfonic acid and mixtures thereof. Preferred sulfonic acids, functioning as precursors to the alkyl benzene sulfonates useful for compositions herein, are those in which the alkyl chain is linear and averages about 8 to 16 carbon atoms (C₈-C₁₆) in length. Examples of commercially available alkyl benzene sulfonic acids useful in the present invention include Calsoft® LAS-99, Calsoft®LPS-99 or Calsoft®TSA-99 marketed by Pilot Chemical. Most preferred for use in the present invention is sodium dodecylbenzene sulfonate, available commercially as the sodium salt of the sulfonic acid, for example Calsoft® F-90, Calsoft® P-85, Calsoft® L-60, Calsoft® L-50, or Calsoft® L-40. Also of possible use in the present invention, and depending on stability with hypochlorite, are the ammonium salts, lower alkyl ammonium salts and the lower alkanol ammonium salts of linear alkyl benzene sulfonic acid, such as triethanol ammonium linear alkyl benzene sulfonate including Calsoft® T-60 sold by Pilot Chemical. If incorporated as an additional anionic surfactant in the present invention, the preferred level of sulfonate is from about 0.1% to about 10%. Most preferred is to use sodium dodecylbenzene sulfonate at a level of from about 0.1% to about 2%. Also of use in the present invention are the xylene, cumene, and naphthalene sulfonates that function more as hydrotropes rather than detersive surfactants. Most preferred for use as hydrotropes in the present compositions are sodium xylene sulfonate and sodium cumene sulfonate, at from about 0.01% to about 2% by weight to the total composition. Hydrotropes such as these sulfonates have been known to mitigate filming and streaking in alkaline cleaning compositions.

Also with respect to the optional anionic surfactants useful in the cleaning system, the alkyl ether sulfates, also known as alcohol ether sulfates, are preferred. Alcohol ether sulfates are the sulfuric monoesters of the straight chain or branched alcohol ethoxylates and have the general formula R—(CH₂CH₂O)ₓ—SO₃M, where R—(CH₂CH₂O)ₓ— preferably comprises C₇-C₂₁ alcohol ethoxylated with from about 0.5 to about 9 mol of ethylene oxide (i.e. x=0.5 to 9 EO), such as C₁₂-C₁₈ alcohols containing from 0.5 to 9 EU, and where M is alkali metal or ammonium, alkyl ammonium or alkanol ammonium counterion. Preferred alkyl ether sulfates include C₈-C₁₈ alcohol ether sulfates with a degree of ethoxylation of from about 0.5 to about 9 ethylene oxide moieties and most preferred are the C₁₂-C₁₅ alcohol ether sulfates with ethoxylation from about 4 to about 9 ethylene oxide moieties, with 7 ethylene oxide moieties being most preferred. It is understood that when referring to alkyl ether sulfates, these substances are already salts (hence designated “sulfonate”), and most preferred and most readily available are the sodium alkyl ether sulfates (also referred to as NaAES). Commercially available alkyl ether sulfates include the CALFOAM® alcohol ether sulfates from Pilot Chemical, the EMAL®, LEVENOL® and LATEMAL® products from Kao Corporation, and the POLYSTEP® products from Stepan, however most of these have fairly low EO content (e.g., average 3 or 4-EO). Alternatively the alkyl ether sulfates for use in the present invention may be prepared by sulfonation of alcohol ethoxylates (i.e., nonionic surfactants) if the commercial alkyl ether sulfate with the desired chain lengths and EO content are not easily found, but perhaps where the nonionic alcohol ethoxylate starting material may be. For example, sodium lauryl ether sulfate (“sodium laureth sulfate”, having about 3 ethylene oxide moieties) is very readily available commercially and quite common in shampoos and detersives, however, this is not the preferred level of ethoxylation for use in the present invention for hard surface cleaning. Therefore it may be more practical to sulfonate a commercially available nonionic surfactant such as Neodol® 25-7 Primary Alcohol Ethoxylate (a C₁₂-C₁₅/7EO nonionic from Shell) to obtain the C₁₂-C₁₅/7EO alkyl ether sulfate that may have been difficult to source commercially. The preferred level of C₁₂-C₁₈/0.5-9EO alkyl ether sulfate in the present invention is from about 0.1% to about 10%. Most preferred is from about 0.1% to about 2%.

Fatty soaps may also be incorporated in the present cleaning system as an additional anionic detersive component as these are particularly suitable to aid in fat and grease removal from hard surfaces. As used here, “fatty soap” means the salts of fatty acids. For example, the fatty soaps that may be used here have general formula R—CO₂M, wherein R represents a linear or branched alkyl or alkenyl group having between about 8 and 24 carbons and M represents a counterion such as sodium, potassium or magnesium, or ammonium or alkyl- or dialkyl- or trialkyl-ammonium or alkanol-ammonium cation. The fatty acid soaps suitable for emulsifying soils is preferably comprised of higher fatty acid soaps. That fatty acids that may be the feed stock to the fatty soaps may be obtained from natural fats and oils, such as those from animal fats and greases and/or from vegetable and seed oils, for example, tallow, hydrogenated tallow, whale oil, fish oil, grease, lard, coconut oil, palm oil, palm kernel oil, olive oil, peanut oil, corn oil, sesame oil, rice bran oil, cottonseed oil, babassu oil, soybean oil, castor oil, and mixtures thereof. Fatty acids can be synthetically prepared, for example, by the oxidation of petroleum, or by hydrogenation of carbon monoxide by the Fischer-Tropsch process. The fatty acids of particular use in the present invention are linear or branched and containing from about 8 to about 24 carbon atoms, preferably from about 10 to about 20 carbon atoms and most preferably from about 14 to about 18 carbon atoms. Preferred fatty acids for use in the present invention are tallow or hydrogenated tallow fatty acids and their preferred salts (soaps) are salts, such as sodium, potassium, or magnesium, or mixtures thereof. Other useful soaps are ammonium and alkanol-ammonium salts of fatty acids depending on stability in presence of hypochlorite. The fatty acids that may be included in the present compositions will preferably be chosen to have desirable surface cleaning efficacy and foam. Of course, the fatty acids may be added as the free acids that are neutralized in situ in the composition by the high alkalinity present. The preferred level of fatty soap in the present invention is from about 0.1% to about 10%. Most preferred is from about 0.1% to about 2%.

Additional anionic surfactants that may find use in the present invention include the alpha-sulfonated alkyl esters of C₁₂-C₁₆ fatty acids. The alpha-sulfonated alkyl esters may be pure alkyl ester or a blend of (1) a mono-salt of an alpha-sulfonated alkyl ester of a fatty acid having from 8-20 carbon atoms where the alkyl portion forming the ester is straight or branched chain alkyl of 1-6 carbon atoms and (2) a di-salt of an alpha-sulfonated fatty acid, the ratio of mono-salt to di-salt being at least about 2:1. The alpha-sulfonated alkyl esters useful herein are typically prepared by sulfonating an alkyl ester of a fatty acid with a sulfonating agent such as SO₃. When prepared in this manner, the alpha-sulfonated alkyl esters normally contain a minor amount, (typically less than 33% by weight), of the di-salt of the alpha-sulfonated fatty acid which results from saponification of the ester. Preferred alpha-sulfonated alkyl esters contain less than about 10% by weight of the di-salt of the corresponding alpha-sulfonated fatty acid.

The alpha-sulfonated alkyl esters, i.e., alkyl ester sulfonate surfactants, include linear esters of C₆-C₂₂ carboxylic acids that are sulfonated with gaseous SO₃. Suitable starting materials preferably include natural fatty substances as derived from tallow, palm oil, etc., rather than from petroleum sources. The preferred alkyl ester sulfonate surfactants, especially for a detersive composition for the present invention, comprise alkyl ester sulfonate surfactants of the structural formula R³—CH(SO₃M)-CO₂R⁴, wherein R³ is a C₈-C₂₀ hydrocarbon chain preferably naturally derived, R⁴ is a straight or branched chain C₁-C₆ alkyl group and M is a cation which forms a water soluble salt with the alkyl ester sulfonate, including sodium, potassium, magnesium, and ammonium cations. Preferably, R³ is C₁₀-C₁₆ fatty alkyl, and R⁴ is methyl or ethyl. Most preferred are alpha-sulfonated methyl or ethyl esters of a distribution of fatty acids having an average of from 12 to 16 carbon atoms. For example, the alpha-sulfonated esters Alpha-Step® BBS-45, Alpha-Step® MC-48, and Alpha-Step® PC-48, all available from the Stepan Co. of Northfield, Ill., may find use in the present invention. Alpha-sulfonated fatty acid ester surfactants may be used at a level of from about 0.1% to about 5% and most preferably at a level of from about 0.1% to about 2% by weight in the detersive composition.

Lastly, the cleaning system of the present invention may include ether carboxylates or (ether carboxylic acids neutralized in situ to carboxylates) as an additional anionic ingredient, having the general formula: R—[OCH₂CH₂]ᵤ—[O(CH₂)ₓCH(R′)(CH₂)_{y}—CH(R″)(CH₂)_{z}]ᵥ—[OCH₂CH₂]_{w}—OCH₂—COOM, where R is a hydrocarbon radical containing 6 to 28 carbon atoms; u and v may be the same or different and from about 0 to 30, u being 0 where v is 0; w is from about 1 to 30, the sum of u, v, and w being less than or equal to 30; x, y and z are independent of one another and are either 0 or 1; R′ and R″ may independently be hydrogen, methyl or ethyl; the sum of x, y, and z being >0 where R′═R″═H; M is an alkali metal or alkaline earth metal (for the ether carboxylates) or hydrogen (for the ether carboxylic acids that will be neutralized in the alkaline composition). Ether carboxylates corresponding to this general chemical formula may be obtained by alkoxylation, (e.g. ethoxylation, propoxylation, or mixture of the two processes). The sum of u, v, and w in the formula above represents the total degree of alkoxylation of the ether carboxylate. Although on a molecular level the numbers u, v and w and the total degree of alkoxylation can only be integers, including zero, on a macroscopic level they are average values and usually in the form of non-integers. Referring still to this general formula for ether carboxylates/carboxylic acids, R may be linear or branched, acyclic or cyclic, saturated or unsaturated, aliphatic or aromatic, but is preferably a linear or branched, acyclic C₆-C₂₂ alkyl or alkenyl group, or a C₁-C₂₂ alkyl phenyl group, and more particularly a C₈-C₁₈ alkyl or alkenyl group, or a C₄-C₁₆ alkyl phenyl group, and more preferably a C₁₀-C₁₆ alkyl group; the sum of u, v, and w is preferably from about 2 to about 20, and more preferably from about 3 to about 17, and most preferably from about 5 to about 15; the sum of x, y and z is preferably no greater than 2, more preferably no greater than 1, and most preferably 0; R′ and R″ are preferably hydrogen, methyl, or R′ is methyl and R″ is hydrogen; and, M is preferably lithium, sodium, potassium, calcium or magnesium, of which sodium and potassium are most preferred. Preferred ether carboxylates for the present cleaning system include the mixed adducts of propylene oxide (where v is greater than 0; x, y, and z are each 0; R′═H, R″=Me R′=Me, R″═H) and ethylene oxide (u is 0, or u is greater than 0) corresponding to the formula: R—[OCH₂CH₂]ᵤ—[OCH(R′)CH(R″)_{z}]ᵥ—[OCH₂CH₂]_{w}—OCH₂—COOM, and more particularly those compounds in which u is O, R′=Me and R″═H within the general formula: R—[OCH(CH₃)CH₂]_{V}—[OCH₂CH₂]_{W}—OCH₂—COOM. Since the foaming hypochlorite-based compositions according to the present invention are highly alkaline, the ether carboxylates may also be replaced by the ether carboxylic acids (M=H in any of the above formulas) which are neutralized in situ upon their introduction into the mixture. Accordingly, suitable ether carboxylates or corresponding ether carboxylic acids include the following representatives referred to by their INCI names (INCI: nomenclature for raw materials according to the International Cosmetic Ingredient Dictionary, 7th Edition, published by the Cosmetic, Toiletry and Fragrance Association Inc. (CTFA), Washington D.C., USA): Butoxynol-5 Carboxylic Acid, Butoxynol-19 Carboxylic Acid, Capryleth-4 Carboxylic Acid, Capryleth-6 Carboxylic Acid, Capryleth-9 Carboxylic Acid, Ceteareth-25 Carboxylic Acid, Coceth-7 Carboxylic Acid, C9-11 Pareth-6 Carboxylic Acid, C11-15 Pareth-7 Carboxylic Acid, C12-13 Pareth-5 Carboxylic Acid, C12-13 Pareth-8 Carboxylic Acid, C12-13 Pareth-12 Carboxylic Acid, C12-15 Pareth-7 Carboxylic Acid, C12-15 Pareth-8 Carboxylic Acid, C14-15 Pareth-8 Carboxylic Acid, Deceth-7 Carboxylic Acid, Laureth-3 Carboxylic Acid, Laureth-4 Carboxylic Acid, Laureth-5 Carboxylic Acid, Laureth-6 Carboxylic Acid, Laureth-8 Carboxylic Acid, Laureth-10 Carboxylic Acid, Laureth-11 Carboxylic Acid, Laureth-12 Carboxylic Acid, Laureth-13 Carboxylic Acid, Laureth-14 Carboxylic Acid, Laureth-17 Carboxylic Acid, Magnesium Laureth-11 Carboxylate, Sodium-PPG-6-Laureth-6-Carboxylate, Sodium PPG-8-Steareth-7 Carboxylate, Myreth-3 Carboxylic Acid, Myreth-5 Carboxylic Acid, Nonoxynol-5 Carboxylic Acid, Nonoxynol-8 Carboxylic Acid, Nonoxynol-10 Carboxylic Acid, Octeth-3 Carboxylic Acid, Octoxynol-20 Carboxylic Acid, Oleth-3 Carboxylic Acid, Oleth-6 Carboxylic Acid, Oleth-10 Carboxylic Acid, PPG-3-Deceth-2 Carboxylic Acid, Sodium Capryleth-2 Carboxylate, Sodium Capryleth-9 Carboxylate, Sodium Ceteth-13 Carboxylate, Sodium C9-C11 Pareth-6 Carboxylate, Sodium C11-C15 Pareth-7 Carboxylate, Sodium C12-C13 Pareth-5 Carboxylate, Sodium C12-C13 Pareth-8 Carboxylate, Sodium C12-C13 Pareth-12 Carboxylate, Sodium C12-C15 Pareth-6 Carboxylate, Sodium C12-C15 Pareth-7 Carboxylate, Sodium C12-C15 Pareth-8 Carboxylate, Sodium C14-C15 Pareth-8 Carboxylate, Sodium Deceth-2 Carboxylate, Sodium Hexeth-4 Carboxylate, Sodium Isosteareth-6 Carboxylate, Sodium Isosteareth-11 Carboxylate, Sodium Laureth-3 Carboxylate, Sodium Laureth-4 Carboxylate, Sodium Laureth-5 Carboxylate, Sodium Laureth-6 Carboxylate, Sodium Laureth-8 Carboxylate Sodium Laureth-11 Carboxylate, Sodium Laureth-12 Carboxylate, Sodium Laureth-13 Carboxylate, Sodium Laureth-14 Carboxylate, Sodium-Laureth-17 Carboxylate, Sodium-Trudeceth-3 Carboxylate, Sodium Trideceth-6 Carboxylate, Sodium Trideceth-7 Carboxylate, Sodium Trideceth-8 Carboxylate, Sodium Trideceth-12 Carboxylate, Sodium Undeceth-5 Carboxylate, Trideceth-3 Carboxylic Acid, Trideceth-4 Carboxylic Acid, Trideceth-7 Carboxylic acid, Trideceth-15 Carboxylic Acid, Trideceth-19 Carboxylic Acid, and Undeceth-5 Carboxylic Acid. The most preferred ether carboxylates are the ethoxylated compounds corresponding to the general formula: R—[OCH₂CH₂]_{W}—OCH₂—COOM, in which R, w and M are as defined as above, R is preferably a C₁₀-C₁₆ alkyl group, w is preferably from about 3 to about 17, and M is preferably sodium ion. The most preferred ethoxylated anionic surfactants include the sodium lauryl ether carboxylates with a degree of ethoxylation from about 5 to 15, for example Sodium Laureth-6 Carboxylate (i.e. where w is 6) or Sodium Laureth-11 Carboxylate (i.e. where w is 11). A very useful blend for incorporation in the present cleaning system is Akypo® TFC-S, available from Kao GmbH, which is a chlorine bleach stable blend of Laureth-5-carboxylic acid and sodium n-octyl sulfate. When incorporated in the present invention, the ether carboxylate surfactant may be used from about 0.1% to about 2% by weigh active material to total weight of the composition.

As mentioned, the cleaning system of the present invention may optionally include a nonionic surfactant. Most preferred for use as an optional nonionic surfactant is an amine oxide due to its foam height and bleach stability. Preferred amine oxides comprise the general formula R¹R²R³N⁺—O⁻, where R¹ is a C₆₋₃₀ alkyl, and R² and R³ are C₁₋₆ alkyl or hydroxyalkyl, and where R² and R³ may be the same or different substituents on the nitrogen. Preferred amine oxide surfactants include, but are not limited to, alkyl di-(hydroxy lower alkyl) amine oxides, alkylamidopropyl di-(lower alkyl) amine oxides, alkyl di-(lower alkyl) amine oxides, and/or alkylmorpholine N-oxides, wherein the alkyl group has 5-25 carbons and may be branched, straight-chain, saturated, and/or unsaturated. The most preferred amine oxides for the present invention include, but are not limited to, lauryl dimethyl amine oxide sold as aqueous solutions under the name Barlox® 12 from Lonza and Ammonyx® LO from Stepan. The amine oxide surfactants are preferably incorporated at a level of from about 0.1% to about 5% and most preferably from about 0.1% to about 2% by weight in the aqueous composition.

Also preferred for use as an optional nonionic surfactant are the alkyl polyglycoside surfactants. The alkyl polyglycosides (commonly referred to as APG's), also called alkyl polyglucosides if the saccharide moiety is glucose, are naturally derived, nonionic surfactants. The alkyl polyglycosides that may be used in the present invention are fatty ester derivatives of saccharides or polysaccharides that are formed when a carbohydrate is reacted under acidic conditions with a fatty alcohol through condensation polymerization. The APG's are typically derived from corn-based carbohydrates and fatty alcohols from natural oils found in animals, coconuts and palm kernels. Such methods for deriving APG's are well known in the art. The alkyl polyglycosides that are preferred for use in the present invention contain a hydrophilic group derived from carbohydrates and is composed of one or more anhydroglucose units. Each of the glucose units may have two ether oxygen atoms and three hydroxyl groups, along with a terminal hydroxyl group, which together impart water solubility to the glycoside. The presence of the alkyl carbon chain leads to the hydrophobic tail of the molecule.

When carbohydrate molecules react with fatty alcohol compounds, alkyl polyglycoside molecules are formed having single or multiple anhydroglucose units, which are termed monoglycosides and polyglycosides, respectively. The final alkyl polyglycoside product typically has a distribution of glucose units (i.e., degree of polymerization).

The APG's that may be used in the present invention preferably comprise saccharide or polysaccharide groups (i.e., mono-, di-, tri-, etc. saccharides) of hexose or pentose, and a fatty aliphatic group having 6 to 20 carbon atoms. Preferred alkyl polyglycosides that can be used according to the present invention are represented by the general formula, Gₓ-O—R¹, wherein G is a moiety derived from reducing saccharide containing 5 or 6 carbon atoms, e.g., pentose or hexose; R¹ is fatty alkyl group containing 6 to 20 carbon atoms; and x is the degree of polymerization of the polyglycoside, representing the number of monosaccharide repeating units in the polyglycoside. Generally, x is an integer on the basis of individual molecules, but because there are statistical variations in the manufacturing process for APG's, x may be a non-integer on an average basis when referred to particular APG's of use as an ingredient for the detersive composition of the present invention. For the APG's preferred for use herein, x preferably has a value of less than 2.5, and more preferably is between 1 and 2. Exemplary saccharides from which G can be derived are glucose, fructose, mannose, galactose, talose, gulose, allose, altrose, idose, arabinose, xylose, lyxose and ribose. Because of the ready availability of glucose, glucose is preferred in polyglycosides. The fatty alkyl group is preferably saturated, although unsaturated fatty chains may be used. Generally, the commercially available polyglycosides have C₈ to C₁₆ alkyl chains and an average degree of polymerization of from 1.4 to 1.6.

Commercially available alkyl polyglycoside can be obtained as concentrated aqueous solutions ranging from 50 to 70% actives and are available from Cognis. Most preferred for use in the present compositions are APG's with an average degree of polymerization of from 1.4 to 1.7 and the chain lengths of the aliphatic groups are between C₈ and C₁₆. For example, one preferred APG for use herein has chain length of C₈ and C₁₀ (ratio of 45:55) and a degree of polymerization of 1.7. The cleaning composition preferably includes a sufficient amount of alkyl polyglycoside surfactant in an amount that provides a desired level of cleaning of soils found in homes and institutions. Preferably, the cleaning composition includes between about 0.1% and about 5% by weight alkyl polyglycoside surfactant and more preferably APG® 325N or Glucopon® 215 from Cognis at between about 0.1% and 2.0% by weight active alkyl polyglucoside surfactant to the total aqueous composition.

Also useful as optional nonionic surfactants in the present cleaning system are the ethoxylated and/or propoxylated primary alcohols having 10 to 18 carbon atoms and on average from 4 to 12 moles of ethylene oxide (EO) and/or from 1 to 10 moles of propylene oxide (PO) per mole of alcohol. Further examples are alcohol ethoxylates containing linear radicals from alcohols of natural origin having 12 to 18 carbon atoms, e.g., from coconut, palm, tallow fatty or oleyl alcohol and on average from 4 to about 12 EO per mole of alcohol. Somewhat useful as a nonionic surfactant in the present invention is the C₁₄-C₁₅ alcohol ethoxylate-7EO and the C₁₂-C₁₄ alcohol ethoxylate-12EO incorporated from about 1% to about 70%, for example at a level of from about 1% to about 20%. Nonionic ethoxylate surfactants that may find use herein include for example, Neodol® 45-7, Neodol® 25-9, or Neodol® 25-12 from Shell Chemical Company. Most preferred are Neodol® 45-7, which is a C₁₄-C₁₅ alcohol ethoxylate-7EO and Surfonic® L24-12, available from Huntsman, which is a C₁₂-C₁₄ alcohol ethoxylate-12EO surfactant (or the Neodol® 25-12 from Shell which is the petroleum feedstock derived material that is substantially similar in performance). Combinations of more than one alcohol ethoxylate surfactant may also be desired in the detersive composition in order to maximize cleaning of various home and institutional surfaces. Alcohol ethoxylate nonionic surfactants are preferably incorporated at a level of from about 0.1% to about 10% by weight and most preferably from about 0.1% to about 2.0% by weight in the total aqueous composition.

The present cleaning system may also include an amide type nonionic surfactant, for example alkanolamides that are condensates of fatty acids with alkanolamines such as monoethanolamine (MEA), diethanolamine (DEA) and monoisopropanolamine (MIPA), that have found widespread use in cosmetic, personal care, household and industrial formulations. Useful alkanolamides include ethanolamides and/or isopropanolamides such as monoethanolamides, diethanolamides and isopropanolamides in which the fatty acid acyl radical typically contains from 8 to 18 carbon atoms. Especially satisfactory alkanolamides have been mono- and diethanolamides such as those derived from coconut oil mixed fatty acids or special fractions containing, for instance, predominately C₁₂ to C₁₄ fatty acids. For most applications, alkanolamides prepared from trialkylglycerides are considered most practical due to lower cost, ease of manufacturing and acceptable quality. Of use in the present invention are mono- and diethanolamides derived from coconut oil mixed fatty acids, (predominately C₁₂ to C₁₄ fatty acids), such as those available from McIntyre under the brand name Mackamide®. Most preferred is Mackamide® CMA, which is coconut monoethanolamide available from McIntyre. If used, the amide surfactants are preferably incorporated at a level of from about 0.1% to about 10% and most preferably from about 0.1% to about 2% by weight in the aqueous composition.

As mentioned, the cleaning system of the present invention may also include an optional amphoteric surfactant such as a betaine surfactant. Suitable betaines include, but are not limited to, the alkylbetaines, the alkylamidobetaines, the imidazoliniumbetaines, the sulfobetaines (INCI sultaines) and the phosphobetaines, conforming to the general formula R¹—[CO—X—(CH₂)ₙ]ₓ—N⁺(R²)(R³)—(CH₂)ₘ—[CH(OH)—CH₂]_{y}—Y⁻ (I) in which: R¹ is a saturated or unsaturated C₆₋₂₂-alkyl radical, preferably C₈-C₁₈-alkyl radical, in particular a saturated C₁₀₋₁₆-alkyl radical, for example a saturated C₁₂₋₁₄-alkyl radical; X is NH, NR⁴ with the C₁₋₄-alkyl radical R⁴, O or S; n is a number from 1 to 10, preferably from 2 to 5, in particular 3; x is 0 or 1, preferably 1; R², R³ are each independently C₁₋₄-alkyl radicals, optionally hydroxyl-substituted, for example a hydroxyethyl radical, but in particular a methyl radical; m is a number from 1 to 4, in particular 1, 2 or 3; y is 0 or 1; and, Y is COO, SO₃, OPO(OR⁵)O or P(O)(OR⁵)O, where R⁵ is a hydrogen atom H or a C₁₋₄-alkyl radical. The alkyl- and alkylamidobetaines, betaines of the above general formula having a carboxylate group (Y⁻═COO⁻), are also called carbobetaines. Preferred amphoteric surfactants include the alkylbetaines of the general formula R¹—N⁺(CH₃)₂—CH₂COO⁻, the alkylamidobetaines of the general formula R¹—CO—NH—(CH₂)₃—N⁺(CH₃)₂—CH₂COO⁻, the sulfobetaines of the general formula R¹—N⁺(CH₃)₂—CH₂CH(OH)CH₂SO₃⁻, and the amidosulfobetaines of the general formula R¹—CO—NH—(CH₂)₃—N⁺(CH₃)₂—CH₂CH(OH)CH₂SO₃⁻(Id), in which R¹ is as defined in the preceding introduction to betaines. Examples of suitable betaines and sulfobetaines include, but are not limited to, the following compounds named in accordance with INCI: Almondamidopropyl Betaine, Apricotamidopropyl Betaine, Avocadamidopropyl Betaine, Babassuamidopropyl Betaine, Behenamidopropyl Betaine, Behenyl Betaine, Betaine, Canolamidopropyl Betaine, Capryl/Capramidopropyl Betaine, Carnitine, Cetyl Betaine, Cocamidoethyl Betaine, Cocamidopropyl Betaine, Cocamidopropyl Hydroxysultaine, Coco-Betaine, Coco-Hydroxysultaine, Coco/Oleamidopropyl Betaine, Coco-Sultaine, Decyl Betaine, Dihydroxyethyl Oleyl Glycinate, Dihydroxyethyl Soy Glycinate, Dihydroxyethyl Stearyl Glycinate, Dihydroxyethyl Tallow Glycinate, Dimethicone Propyl PG-Betaine, Erucamidopropyl Hydroxysultaine, Hydrogenated Tallow Betaine, Isostearamidopropyl Betaine, Lauramidopropyl Betaine, Lauryl Betaine, Lauryl Hydroxysultaine, Lauryl Sultaine, Milkamidopropyl Betaine, Minkamidopropyl Betaine, Myristamidopropyl Betaine, Myristyl Betaine, Oleamidopropyl Betaine, Oleamidopropyl Hydroxysultaine, Oleyl Betaine, Olivamidopropyl Betaine, Palmamidopropyl Betaine, Palmitamidopropyl

Betaine, Palmitoyl Carnitine, Palm Kernelamidopropyl Betaine, Polytetrafluoroethylene Acetoxypropyl Betaine, Ricinoleamidopropyl Betaine, Sesamidopropyl Betaine, Soyamidopropyl Betaine, Stearamidopropyl Betaine, Stearyl Betaine, Tallowamidopropyl Betaine, Tallowamidopropyl Hydroxysultaine, Tallow Betaine, Tallow Dihydroxyethyl Betaine, Undecylenamidopropyl Betaine and Wheat Germamidopropyl Betaine. The preferred betaines for use in the present cleaning system include cetyl betaine and/or lauryl betaine, and preferably in an amount of from about 0.01% to about 1% by weight actives to the total composition.

Builders

The cleaning system may also include a builder that can add even additional alkalinity to the cleaning composition beyond what is incorporated from the hypochlorite, and may add surface/corrosion protection. Such builders may include but are not limited to hydroxides, carbonates, bicarbonates, silicates, borates, zeolites, phosphates, citrates, and the like, at a level of from about 0.001% to about 5% by weight active material. More useful in the present invention is sodium, potassium or magnesium hydroxide, and optionally any sodium, potassium, or magnesium, or mixed silicate, or combinations thereof.

The preferred silicate is an alkali metal silicate salt (the alkali metal salts of silicic acid) with the sodium and potassium silicate salts being the most preferred. The alkali metal silicates that are useful may be in a variety of forms that can be described by the general formula M₂O:SiO₂, wherein M represents the alkali metal and in which the ratio of the two oxides varies. Most useful alkali metal silicates will have a SiO₂/M₂O weight ratio of from about 1.6 to about 4. Preferred silicates include the Sodium Silicate Solutions from PQ Corporation, such as A®1647 Sodium Silicate Solution, a 46.8% active solution of sodium silicate having a SiO₂/Na₂O ratio of about 1.6 to about 1.8:1. Also of use in the compositions of the present invention are the potassium silicates, such as the Kasil® products from PQ Corporation. For example, Kasil®1 Potassium Silicate Solution is a 29.1% solution of potassium silicate having a SiO₂/K₂O ratio of about 2.5. It is preferable to use either sodium or potassium silicate at a level of from about 0.001% to about 1.0% in the compositions of the present invention. Also of use is sodium metasilicate and sodium silicate, such as the hydrous sodium silicate Britesil® C24 available from PQ Corporation.

It is preferred to incorporate any of the above mentioned builders at from about 0.001% to about 2% by weight active material in the detersive composition. It is most preferred to also incorporate a silicate in order to protect against corrosion of metal surfaces from the hypochlorite. Most preferred is to use sodium, potassium or magnesium hydroxide by itself as the builder, or a mixture of sodium hydroxide and sodium silicate as the builders at a total weight of actives of from about 0.001% to about 2% based on the total composition. With addition of hydroxide, the pH of the final cleaning system is preferably greater than 11, and more preferably over 12.

Buffer Component

The aqueous compositions for the present cleaning system may also comprise at least one organic or inorganic acid, mixtures of organic acids, mixtures of inorganic acids, or various combinations of organic and inorganic acids, in order to buffer the composition preferably above pH 11 and more preferably over 12, and to more reliably target a specific pH in manufacturing. The organic or inorganic acids for use as buffer in the present invention may be any known to those skilled in specialty chemicals and formulating cleaners, however, it is preferred to use at least one organic acid. With the proper selection of acidic buffer, there may be an added chelation effect. The acidic buffers that may find use in the present invention include citric, lactic, oxalic, formic, nitric, sulfuric, sulfamic, phosphoric, and hydrochloric acids. Other organic and inorganic acids that may find use in the present invention include, but are not limited to, maleic acid, sorbic acid, benzoic acid, p-hydroxybenzoic acid, glutaric acid, glycolic acid, ethylenediaminetetraacetic acid, polyphosphoric acid, aspartic acid, acetic acid, hydroxyacetic acid, propionic acid, hydroxypropionic acid, α-ketopropionic acid, butyric acid, mandelic acid, valeric acid, succinic acid, tartaric acid, malic acid, fumaric acid, adipic acid, and mixtures thereof. When used as an acidic buffer, any acid or combination of these acids are preferably used at a level of from about 0.001% to about 1.0% by weight to the total composition. Most preferred is to use citric acid at from about 0.1% to about 1%, and some citrate (such as trisodium- or disodium- or monosodium citrate) may have been added as a builder (as described above).

Chelating Agents

Chelating agents may be incorporated in the detersive compositions herein in amounts ranging from 0.001% to 20% by weight of the total composition, preferably from about 0.01% to about 5%. Particularly preferred for use herein are amino carboxylate chelants including salicylic acid, aspartic acid, glutamic acid, glycine, malonic acid, ethylene diamine tetraacetates (EDTA), diethylene triamine pentaacetates, diethylene triamine pentaacetate (DTPA), N-hydroxyethylethylenediamine triacetates, nitrilotriacetates, ethylenediamine tetrapropionates, triethylenetetraaminehexa-acetates, ethanol-diglycines, propylene diamine tetracetic acid (PDTA) and methyl glycine diacetic acid (MGDA), both in their acid form, or in their alkali metal, ammonium, and substituted ammonium salt forms or partial salt forms. Particularly suitable amino carboxylates to be used herein are diethylene triamine penta acetic acid, propylene diamine tetracetic acid (PDTA) which is, for instance, commercially available from BASF under the trade name Trilon FS® and trisodium methyl glycine diacetic acid (MGDA) available from BASF under the trade name Trilon M®.

Other suitable chelating agents for use herein may include alkali metal ethane 1-hydroxy diphosphonates (HEDP), alkylene poly (alkylene phosphonate), as well as amino phosphonate compounds, including amino aminotri(methylene phosphonic acid) (ATMP), nitrilo trimethylene phosphonates (NTP), ethylene diamine tetra methylene phosphonates, and diethylene triamine penta methylene phosphonates (DTPMP). The phosphonate compounds may be present either in their acid form or as salts of different cations on some or all of their acid functionalities. Preferred phosphonate chelating agents to be used herein are diethylene triamine penta methylene phosphonate (DTPMP) and ethane 1-hydroxy diphosphonate (HEDP). Such phosphonate chelating agents are commercially available from Monsanto under the trade name DEQUEST®. Any of the above mentioned chelants may be used at from about 0.001% to about 20% by weight in the aqueous cleaner composition.

Water and Optional Solvents

As emphasized throughout, the cleaning compositions for use in the present cleaning system are aqueous, and in fact are preferably highly aqueous. With that said, the compositions herein will typically incorporate at least 50% by weight water, and most preferably at least 80% by weight of water. Solvents may be included in these compositions along with the water as is typically seen in many spray cleaners. For example, alcohols, diols, and glycol ethers may be used in addition to water as co-solvent for the present compositions. Solvents, particularly the glycol ether solvents pioneered by Dow Chemical and Union Carbide, allow dissolution of soils directly, and assist the surfactants in soil removal. Furthermore, solvents improve drying time and shine when the cleaner is simply used as “spray-and-wipe.” Most preferred for use in the present invention are ethanol, isopropanol, propylene glycol, ethylene glycol n-butyl ether, propylene glycol n-butyl ether, propylene glycol mono-methyl ether, propylene glycol mono-phenyl ether, and propylene glycol dimethyl ether at from about 0.1% to about 5% by weight of the total composition.

Miscellaneous Adjuvant

The detersive composition preferably includes a fragrance, in particular to mask the hypochlorite bleach odor. It is desirable to add sufficient fragrance that can be perceived while cleaning and to impart at least a temporarily lasting scent after the surfaces are cleaned. This may require; the use of substantive fragrances that have an increased longevity due to the nature of the fragrance components themselves (i.e. less volatile ingredients); the use of a fairly large amount of fragrance; and/or, the use of encapsulated fragrance(s), or combinations of these ideas. In the simplest embodiment, a fragrance typically used in cleaning compositions (e.g. lemon, orange, pine, floral, mint, etc.) may be incorporated in the detersive composition at from about 0.001% to about 5% by weight. At this level, some perceivable fragrance is likely to remain temporarily even after cleaning of surfaces. If it is expected that the present cleaning system is to be used on food contact surfaces, the levels of fragrance may be reduced.

Encapsulated fragrances are well known in the art, and may find for use in the detersive composition of the present invention to give the composition a longer-lasting fragrance in storage. Encapsulation of fragrance has been described in many prior art references, including but not limited to; U.S. Pat. No. 7,338,928 to Lau et al.; U.S. Pat. No. 7,294,612 to Popplewell et al.; U.S. Pat. No. 7,196,049 to Brain et al.; U.S. Pat. No. 7,125,835 to Bennett et al.; U.S. Pat. No. 7,122,512 to Brain et al.; U.S. Pat. No. 7,119,057 to Popplewell et al.; U.S. Pat. No. 6,147,046 to Shefer et al.; U.S. Pat. No. 6,142,398 to Shefer et al.; U.S. Pat. No. 4,446,032 to Munteanu et al.; and, U.S. Pat. No. 4,464,271 to Munteanu, each of which is incorporated herein by reference. Fragrance encapsulation has been optimized and is available through various suppliers, most notably LIPO Technologies, Inc., Vandalia, Ohio, and Alco Chemical, Chattanooga, Tenn., (e.g. using Alcocap® natural polymers for encapsulation). Encapsulation is described thoroughly in “Microencapsulation: Methods and Industrial Applications”, Benita (Ed.), Marcel Dekker, Inc., New York, 1996. Fragrance microcapsules obtained from LIPO, Alco, or the fragrance houses, or as obtained through any of these published methods may be incorporated in the detersive compositions of the present cleaning system herein at from about 0.001% to about 0.05% by weight in the liquid composition.

The cleaning system may also contain colorants or dyes. Dyes are optional ingredients within the compositions of the present invention since color may or may not be visible through the sprayer bottle (e.g. if crystal clear, opaque, or colored plastic is blow-molded). Dyes may comprise pigments, or other colorants, chosen so that they are compatible with the other ingredients in the detersive composition, and not staining in the grouting between tiles, worn porcelain, and other porous surfaces that the present cleaning system may encounter. For example, a preferred colorant for use in the present invention is Liquitint® Green FS (from Milliken), at from about 0.001% to about 0.1% by weight, based on the total composition. Other non-limiting examples of dyes include C.I. Pigment Green #7, C.I. Reactive Green #12, F D & C Green #3, C.I. Acid Blue #80, C.I. Acid Yellow #17, Liquitint® Red MX, F D & C Yellow #5, Liquitint® Violet LS, Fast Turquise GLL, Liquitint® Blue MC, Liquitint® Blue HP, or mixtures thereof, which are also useful in the detersive compositions of the present invention.

Optional ingredients that may be included in the detersive composition within the cleaning system include, but are not limited to, additional bleaching agents (peroxygen or chlorine based such as percarbonates, perborates, N-chloroisocyanurates, and the like), enzymes (such as proteases, amylases, lipases, and cellulases and the like), cationic surfactants, thickeners, surface modifying polymers (such as polyvinylpyrrolidone for hydrophilic modification of the hard surfaces for future easier cleaning), emulsifiers, bleach catalysts, bleach stabilizers, enzyme stabilizers, inorganic or organic absorbents, clays, other buffering agents, active salts, abrasives, preservatives (Neolone® Kathon® and the like), and anti-foaming agents (silicones and the like).

Preferred Compositions for the Cleaning System

Table 1 lists fourteen (14) preferred compositions for use in the present foaming hypochlorite cleaning system, labeled Formula 1-Formula 9. The numerical entries in the table represent weight percent (wt. %) of the indicated ingredient on an actives basis, based on the total composition. For example, if a hypothetical composition is manufactured with 16% of a 12.6% solution of sodium hypochlorite and 84% water, the numerical entries in the table for such a formula would be sodium hypochlorite 2.0%, and water 98.0%. That being said, the following fourteen (14) compositions were produced, some of which were tested for performance (foaming, clinging, cleaning) and 5-week storage stability.

TABLE 1
Preferred Foaming Hypochlorite Cleaner Compositions

| Ingredient (weight % active) | 1 | 2 | 3 | 4 | 5 | 6 | 7 |
|---|---|---|---|---|---|---|---|
| Sodium Hypochlorite | 2.00 | 2.00 | 1.40 | 2.00 | 2.00 | 2.00 | 2.00 |
| Sodium Hydroxide | 0.20 | 0.50 | 0.50 | 0.50 | 0.50 | 0.50 | 0.50 |
| Disodium dodecyl diphenyloxide disulfonate | — | 0.68 | 0.90 | 0.56 | 0.79 | 0.90 | 0.45 |
| n-octyl sulfate | 1.05 | 1.05 | 1.05 | 0.92 | 0.84 | 0.63 | 0.42 |
| Lauryl dimethylamine-N-oxide | 0.45 | — | — | — | — | — | — |
| Cetyl betaine | — | — | — | — | — | — | — |
| Lauryl betaine | — | — | — | — | — | — | — |
| Water, fragrance, other misc. adjuvant | q.s. | q.s. | q.s. | q.s. | q.s. | q.s. | q.s. |
| Total | 100.00 | 100.00 | 100.00 | 100.00 | 100.00 | 100.00 | 100.00 |
| Alkyl sulfate:Disulfonate Ratio | — | 1.54 | 1.17 | 1.64 | 1.06 | 0.70 | 0.93 |
| Ingredient (weight % active) | 8 | 9 | 10 | 11 | 12 | 13 | 14 |
| Sodium Hypochlorite | 2.00 | 2.00 | 2.00 | 2.00 | 2.00 | 2.00 | 2.00 |
| Sodium Hydroxide | 0.50 | 0.50 | 0.50 | 0.50 | 0.50 | — | 0.50 |
| Disodium dodecyl diphenyloxide disulfonate | 0.45 | 0.50 | 0.68 | 0.79 | 0.56 | 0.50 | 0.50 |
| Sodium n-octyl sulfate | 0.59 | 0.74 | 0.74 | 0.84 | 0.84 | 0.74 | 0.74 |
| Lauryl dimethylamine-N-oxide | — | — | — | — | — | — | — |
| Cetyl betaine | — | — | — | — | — | 0.30 | — |
| Lauryl betaine | — | — | — | — | — | — | 0.30 |
| Water, misc. adjuvant | q.s. | q.s. | q.s. | q.s. | q.s. | q.s. | q.s. |
| Total | 100.00 | 100.00 | 100.00 | 100.00 | 100.00 | 100.00 | 100.00 |
| Alkyl sulfate:disulfonate Ratio | 1.31 | 1.48 | 1.09 | 1.06 | 1.50 | 1.48 | 1.48 |

Performance Results

Testing included ASTM D4488 tests (A2, A3, A5 soil removal); destaining (juices and foods), rust removal, hard water, lime scale, and calcium carbonate removal, and residue testing (gloss retention after wiping). The results for several of the more preferred formulas appear in Table 2 below:

TABLE 2
PERFORMANCE AND STABILITY RESULTS

| | Formulas (from Table 1) | | | | |
|---|---|---|---|---|---|
| Soils (% soil removal indicated) | 4 | 5 | 6 | 8 | 9 |
| Calcium carbonate deposits | 91.1 | 93.1 | 92.3 | 91.1 | — |
| Lime scale | 95.1 | 93.5 | 93.6 | 92.8 | — |
| Water hardness | 95.5 | 95.9 | 94.7 | 95.9 | — |
| Rust (synthetic) | 85.6 | 85.1 | 86.9 | 85.9 | — |
| ASTM D4488 (A2) | 6.4 | 3.4 | 4.7 | 4.6 | — |
| ASTM D4488 (A3) | 56.7 | 55.6 | 57.5 | 53.6 | — |
| ASTM D4488 (A5) | 51.6 | 58.0 | 52.7 | 55.2 | — |
| Coffee | 49.4 | 41.4 | 43.9 | 46.8 | — |
| Cranberry-Grape juice | 72.9 | 71.1 | 71.3 | 68.4 | — |
| Spaghetti sauce | 77.4 | 77.0 | 89.7 | 83.6 | — |
| Tea | 80.0 | 79.1 | 82.3 | 81.5 | — |
| % Hypochlorite (initial, t = 0) | — | — | — | — | 2.00 |
| % Hypochlorite | — | — | — | — | 1.85 |
| (after 5-weeks at 20° C.) | | | | | |
| % Hypochlorite | — | — | — | — | 1.80 |
| (after 5-weeks at 25° C.) | | | | | |

Residue Testing

Gloss retention (residue) testing was also conducted for one of the most preferred formulas above (Formula 9) and two national brand retail liquid bleach cleaners (Retail Product-1 and Retail Product-2). The residue testing was conducted on previously washed and hand dried gloss black ceramic tiles. All measurements were taken with a BYK-Gardner Gloss Meter (Model 4430), and the gloss evaluated using 60° geometries. 2 mL of the solution was applied to the center of each tile. The tiles were placed in a straight-line scrubbing machine with a damp sponge or a paper towel fitted into the sponge holder. Each tile was subjected to 10 cycles. The tiles were then each removed and allowed to air dry for 30 minutes. The final gloss was measured after any remaining liquid residue on the test tile was dry. The percent (%) Gloss Retained=sample gloss average+clean gloss average. Trials also included using a paper towel rather than a sponge. The results are listed in Table 3 and show that the most preferred Formula 9 outperforms both of two national brand retail products by giving consistently higher gloss retention.

TABLE 3
Residue/Gloss Retention

| Substrate | | | |
|---|---|---|---|
| in Sponge | Product Tested (% Gloss Retained) | | |
| Holder | Formula 9 (Table 1) | Retail Product 1 | Retail Product 2 |
| Damp | 79% | 64% | 66% |
| Sponge | | | |
| Paper Towel | 61% | 52% | 37% |

Foam Heights

Formula 9 from Table 1 showed remarkable foaming, vertical foam cling, and bleach stability. Not being bound to any theory, the n-octyl sulfate, (not considered a high foaming surfactant compared to sodium lauryl sulfate, for example), may be functioning more as a hydrotrope for the disulfonate rather than a foaming surfactant, thus augmenting the foam normally possible from a disodium alkyl diphenyloxide disulfonate surfactant. Foaming and foam cling were tested by dispensing the composition through the preferred OPAD trigger sprayer having the hinging screen snapped in front of the nozzle (the so-called “foam option” selected on the sprayer assembly). Formula 9 showed vertical sag of about 5.5 cm after 30 seconds when foamed as a horizontal line on a vertically oriented porcelain surface. Formula 9 also produced about 10.25 mL of thick foam per trigger spray when the sprayer was equipped with the foam screen. What is truly unexpected and remarkable was that Formula 9 gave only 1.4 mL per spray when the trigger sprayer was not used in the “foam option” configuration (i.e. the foaming screen hinged away from the path of the nozzle). Formula 9 is an exemplary embodiment of the hypochlorite cleaning system herein that may be sprayed as a liquid with a controlled level of foaming yet foamed to a rich lather by selecting the “foam” or “spray” options on the preferred trigger sprayer. It is important to note that other bleach cleaners (most particular, Retail Product 1 and 2 from the gloss retention experiments) did not foam to the same heights as Formula 9 even when foamed through the packaging of the present invention.

Manufacturing and Assembly of the Cleaning System and Methods of Use

Manufacturing and Assembly Methods

The cleaning system of the present invention is manufactured by filling the angled-neck sprayer bottle with the preferred foaming hypochlorite cleaning composition (selected from Table 1) and capping the opening of the bottle with the invertible sprayer assembly. Many methods, including positioning lugs, are available to orient sprayers on the necks of sprayer bottles in only one direction. When incorporating bayonet provisions on the neck of the bottle, it's simpler to lock the sprayer assembly onto the neck of the sprayer bottle in a single orientation.

The foaming hypochlorite compositions of Table 1 are typically made in batches in mixing tanks equipped with simple motor-driven impellers. Such tanks are usually charged with the water first, stirring is then begun and the ingredients including the surfactants and hypochlorite are each added sequentially, allowing for incorporation and time necessary for any in situ neutralization. Dyes and fragrances are usually added at the end of the batch, with the dyes usually dissolved in a small amount of batch water. The finished liquid cleaning composition is then pumped from the mixing tank to filling lines where it can be filled into the angled-neck sprayer bottles by automatic fillers. Depending on the fastening method selected and molded into the bottle necks and sprayer collars (screw threads, bayonet provisions, lugs/ramps), the sprayer assembly is either pushed and snapped onto the neck of each bottle, or threaded on, or twisted on. The dip-tube is first led into the opening of the bottle before the sprayer is lowered down and fastened securely to the opening of the bottle. Unless the bottles have been previously blow-molded with in-mold labeling, a separate labeling step may be used to label each bottle with the necessary branding, marketing puffery, precautionary language, fill/weight information, and use instructions. As mentioned the labeling may be paper or laminate, or even a shrink-wrap around the bottle. Printed literature may accompany the spray bottle/sprayer assembly packaging, for example as a brochure or as a neck hanger.

Methods of Use

The cleaning system of the present invention may be used upright, angled or even upside-down to clean various hard surfaces found in homes and commercial settings. Regardless of the orientation of the sprayer bottle, the cleaning composition is delivered from the angled-neck bottle onto the surface to be cleaned by aiming the nozzle end of the sprayer at the surface to be cleaned and manually pumping the trigger sprayer. With the bottle in the upright position, the best grip may be an ordinary “pistol grip”, with the index finger extended to operate the trigger sprayer, as illustrated in FIG. 2. On the other hand, some users of the present cleaning system in its upside-down orientation may prefer to grip the bottle such that their thumb is available to operate the trigger lever rather than an index finger. This “inverted grip” is illustrated in FIGS. 6 and 7. When using this method to hold the bottle in its inverted orientation, the arm of the hand holding the bottle lends some support, as the bottle tends to lean up against the forearm of the operator. The other hand of the person may be used to support the inverted bottle further by simple grasping of the body of the bottle. As shown in FIG. 7, one method to clean up underneath the rim of a toilet bowl without stooping may involve holding the inverted bottle with this “inverted” grip as shown.

Depending on the surface and soil, the hypochlorite-based product may be sprayed or foamed onto the surface left to dwell for a period of time such as 3, 5, 10, or even 30 minutes before rinsing or wiping, or the product and soils may be immediately wiped or rinsed away. For lightly soiled surfaces the cleaning system may be used as a “spray-and-wipe” cleaner. For heavily soiled and stained surfaces, the product may be left on the surface for several minutes or even longer for thorough destaining, then scrubbed with a scrubbing sponge and rinsed.

Most particularly, the foaming hypochlorite cleaning system herein may be used to clean a toilet. As shown in FIG. 7, an inverted grip on the cleaning system allows the lowering of the sprayer down in the toilet close to the surface of the water. Actuating the trigger sprayer delivers cleaning product up at an acute angle to target under the rim of the toilet bowl. A method for cleaning the inside of a toilet bowl may comprise the steps of: obtaining the cleaning system of the present invention including the composition, the angled neck sprayer bottle and the invertible foaming/spraying trigger sprayer; inverting the cleaning system; holding the inverted cleaning system inside the bowl of the toilet such that the sprayer assembly is below the level of the rim of the toilet; and spraying or foaming the hypochlorite cleaning composition up underneath the rim of the toilet bowl and along the sides of the toilet bowl; and, optionally brushing the toilet bowl with a brush, flushing the toilet to rinse away the cleaning composition and the soils.

Additionally, the foaming hypochlorite cleaning system may be used to clean stoves, range hoods or ovens. The method for cleaning a range hood may comprises the steps of: obtaining the cleaning system of the present invention including the composition, the angled neck sprayer bottle and the invertible foaming/spraying trigger sprayer; selecting either a spray or foam option on the sprayer, if the nozzle provides for such selection; inverting the cleaning system to a nearly upside-down position, with the user grasping the neck of the bottle with a “pistol-grip” or an “inverted-grip” as needed or desired; bringing the sprayer assembly up inside the range hood; spraying/or foaming the hypochlorite-based cleaning composition up underneath the range hood by manually pumping the trigger sprayer and rotating the entire package around to coat all the inside surfaces; optionally scrubbing the range hood surfaces with a suitable kitchen scrubber or simply allowing the cleaning composition to dwell for a period of time sufficient to dissolve all the splattered and dried-on grease; and wiping/rinsing with a wet sponge or cloth.

Additionally, the hypochlorite-based cleaning system may be used to clean an oven found in either residential or commercial settings. The method for cleaning an oven may comprise the steps of: obtaining the cleaning system of the present invention including the composition, the angled neck sprayer bottle and the invertible foaming/spraying trigger sprayer; opening the nozzle of the product to either a spray or foam option, if the nozzle provides for such selection; inverting the cleaning system to a nearly upside-down position, with the user grasping the neck of the bottle with a “pistol-grip” or an “inverted-grip”; bringing the sprayer assembly end first up inside the open oven; spraying/or foaming the hypochlorite cleaning composition up inside the oven by manually pumping the trigger sprayer and rotating the entire package around to coat all the inside surfaces and racks within the oven; optionally scrubbing the oven surfaces with a suitable kitchen scrubber or simply allowing the cleaning composition to dwell for a period of time sufficient to dissolve all the baked-on soils; and rinsing/wiping with a wet sponge or cloth.

We have herein described a unique foaming hypochlorite cleaning system comprising a hypochlorite and anionic surfactant cleaning composition in a package comprising an angled-neck sprayer bottle equipped with an invertible sprayer assembly. One unique aspect to the invention includes the ability to spray bleach cleaning composition upwards at a sharper angle than would be possible by simply inverting a conventional spray cleaner dispensed from a straight-neck bottle. The unusually combination of an angled-neck sprayer bottle and invertible sprayer assembly allow spraying up underneath a range hood and up underneath the rim of a toilet bowl as examples of cleaning hard-to-reach surfaces with less stooping, arm contortions and sprayer failures.

We claim:

1. A foaming hypochlorite cleaning system comprising:
a. a composition comprising:
i. a disulfonate surfactant;
ii. an alkyl sulfate surfactant;
iii. alkali metal or alkaline earth hypo chlorite; and
iv. water;
b. a bottle comprising a body with a relatively flat bottom and an angled-neck with an opening, said bottle having the composition within; and
c. an invertible trigger sprayer assembly fastened to said opening of said bottle, said sprayer comprising a dip tube, trigger lever and nozzle, said sprayer manually operable to expel said composition in a general direction from said nozzle,
wherein the angle of the direction of expelled composition upon operation of said trigger sprayer is from about 3° to about 80° downward from horizontal when said bottom of said bottle rests flat on a horizontal surface.

2. The cleaning system of claim 1, wherein the disulfonate comprises an alkyl substituted diphenyloxide disulfonate salt.

3. The cleaning system of claim 2, wherein the disulfonate comprises disodium dodecyldiphenyloxide disulfonate.

4. The cleaning system of claim 1, wherein the alkyl sulfate comprises n-octyl sulfate.

5. The cleaning system of claim 1, wherein said composition further comprising an anionic surfactant chosen from the group consisting of ether carboxylates, alkyl-benzene sulfonates, olefin sulfonates, hydroxyalkane sulfonates, xylene sulfonate, cumene sulfonate, naphthalene sulfonate, alkyl ether sulfate, fatty acid, and sulfonated carboxylic acid esters, and mixtures thereof.

6. The cleaning system of claim 1, wherein said composition further comprises a nonionic surfactant selected from the group consisting of amine oxide, alkyl polyglycoside, alcohol alkoxylate, and alkanolamide, and mixtures thereof.

7. The cleaning system of claim 1, wherein said composition further comprises a betaine surfactant.

8. The cleaning system of claim 1, wherein said composition further comprises a builder selected from the group consisting of hydroxide, phosphate, silicate, citrate, carbonate, and bicarbonate, and mixtures thereof.

9. The cleaning system of claim 1, wherein said composition further comprises a buffering agent selected from the group consisting of hydrochloric acid, phosphoric acid, sulfamic acid, acetic acid, formic acid, lactic acid, oxalic acid, citric acid, malic acid, and succinic acid, and mixtures thereof.

10. The cleaning system of claim 1, wherein said composition further comprises a chelant selected from the group consisting of ethylenediamine tetraacetate salts, nitrilotriacetate salts, and methyl glycine diacetic acid salts, and mixtures thereof.

11. The cleaning system of claim 1, wherein said composition further includes adjuvant selected from the group consisting of dyes, pigments, fragrance, encapsulated fragrance, preservatives, and bleaching agents, and mixtures thereof.

12. The cleaning system of claim 1, wherein said composition further includes a solvent selected from the group consisting of alcohols, diols, and glycol ethers, and mixtures thereof.

13. The cleaning system of claim 1, wherein said bottle further comprises at least one finger recess configured on said angled-neck.

14. The cleaning system of claim 1, wherein the opening of said bottle is finished with external screw threads.

15. The cleaning system of claim 1, wherein the opening of said bottle is finished with bayonet provisions.

16. The cleaning system of claim 1, further including use instructions.

17. A foaming hypochlorite cleaning system comprising:
a. a composition comprising:
i. disodium alkyl diphenyloxide disulfonate;
ii. sodium alkyl sulfate;
iii. sodium hypochlorite;
iv. sodium hydroxide; and
v. water;
b. a bottle comprising a body with a relatively flat bottom and an angled-neck with an opening, said bottle having the composition within; and
c. an invertible trigger sprayer assembly fastened to said opening of said bottle, said sprayer comprising a dip tube, trigger lever and nozzle, said sprayer manually operable to expel said composition in a general direction from said nozzle,
wherein the angle of the direction of expelled composition is from about 5° to about 45° downward from horizontal when said bottom of said bottle rests flat on a horizontal surface while the trigger sprayer is operated.

18. The cleaning system of claim 17, wherein said composition further includes a silicate.

19. The cleaning system of claim 17, wherein said composition further comprises additional surfactant selected from the group consisting of amine oxide, fatty acid, and ether carboxylate, and mixtures thereof.

20. The cleaning system of claim 17, wherein said nozzle further includes a hinging screen operable in front of said nozzle to convert said spray into a foam delivery.

21. A method for cleaning hard to reach surfaces, said method comprising the steps of:
a. obtaining the cleaning system of claim 1;
b. inverting the cleaning system to a nearly upside-down position;
c. bringing the sprayer assembly up underneath the surface to be cleaned;
d. spraying said composition up underneath the targeted surface by manually pumping the trigger sprayer;
e. optionally scrubbing said surface with a suitable scrubber; and
f. optionally rinsing said surface with water or wiping said surface clean.

22. A method for cleaning the inside of a toilet bowl comprising the steps of:
a. obtaining the cleaning system of claim 1;
b. inverting said cleaning system;
c. holding said inverted cleaning system inside the bowl of the toilet such that said sprayer assembly is below the level of the rim of the toilet; and
d. spraying said composition up underneath the rim of the toilet bowl and along the sides of the toilet bowl;
e. optionally brushing said toilet bowl with a brush; and
f. flushing the toilet to rinse away said composition.
